(19) United States
(12) Patent Application Publication
(10) Pub. No.: US 2025/0020806 A1
(43) Pub. Date: Jan. 16, 2025

(54) FREQUENCY ANGULAR RESOLVING (FAR) LIGHT DETECTION AND RANGING (LIDAR) BY ACOUSTO-OPTIC BEAM STEERING

(71) Applicant: UNIVERSITY OF WASHINGTON, Seattle, WA (US)

(72) Inventors: Mo Li, Seattle, WA (US); Bingzhao Li, Seattle, WA (US); Qixuan Lin, Seattle, WA (US)

(73) Assignee: UNIVERSITY OF WASHINGTON, Seattle, WA (US)

(21) Appl. No.: 18/711,782

(22) PCT Filed: Jan. 26, 2023
(86) PCT No.: PCT/US2023/061401

§ 371 Date: May 20, 2024

Related U.S. Application Data
(60) Provisional application No. 63/303,665, filed on Jan. 27, 2022.
(60) Provisional application No. 63/380,158, filed on Oct. 19, 2022.

(51) Int. Cl. G01S 17/34; G01S 7/481; G01S 7/4912; G01S 17/89; G02F 1/33

(52) U.S. Cl. CPC G01S 17/34; G01S 7/4814; G01S 7/4816; G01S 7/4817; G01S 7/4917; G02F 1/33; G01S 17/89

(57) ABSTRACT

Systems, modules, methods, and machine-readable storage media for Frequency Angular Resolving (FAR) are described. In an embodiment, the system comprises a transmitter and a receiver. In an embodiment, the transmitter comprises a source of electromagnetic radiation; a driver circuit configured to generate a drive signal at an oscillation frequency; an acousto-optical beam steering device optically coupled with the source of electromagnetic radiation and the driver circuit and configured to emit electromagnetic radiation at an emission angle as a function of the oscillation frequency. In an embodiment, the receiver comprises a radiation sensor optically coupled with the source of electromagnetic radiation. In an embodiment, the system comprises an electro-optic modulator optically coupled to the source of electromagnetic radiation, the electro-optic modulator configured to modulate a frequency of light emitted to the acousto-optical beam steering device.

### CROSS-REFERENCE TO RELATED APPLICATIONS

This application claims the benefit of U.S. Provisional Patent Application No. 63/303,665, filed on Jan. 27, 2022; and also claims the benefit of U.S. Provisional Patent Application No. 63/380,158, filed on Oct. 19, 2022, the contents of all of which are hereby incorporated by reference in their entirety.

### STATEMENT OF GOVERNMENT LICENSE RIGHTS

This invention was made with government support under Grant No. NSF OIA2134345, awarded by the National Science Foundation. The government has certain rights in the invention.

### BACKGROUND

Light detection and ranging (LiDAR) affords superior 3D imaging resolution and range, and, therefore is considered an important optical perception technology for intelligent automation systems including autonomous vehicles and robotics. An important component of scanning LiDAR is the optical beam steering system that scans the laser beams in space. Non-mechanical beam steering systems are highly desirable to replace the current mechanical scanners for the advantages of compactness, robustness, speed, and cost. Methods of non-mechanical optical beam steering are generally based on diffractive or dispersive principles. Diffractive methods control the wavefront of the optical beam through a synthetic aperture, which emits light with a tunable phase front toward a controlled direction. Such an artificial aperture can be created using an optical phase array (OPA) or a spatial light modulator (SLM). An alternative technology is the focal plane switch array (FPSA), in which an array of emitters is placed at the focal plane of a lens, and the beams from different emitters are refracted by the lens to different angles. To achieve a large steering angle and a high angular resolution, OPA, SLM, and FPSA universally require a large number of discrete elements, each individually controlled and having a size on the order of the optical wavelength. The need for sophisticated systems to control a large array of elements and the complex fabrication processes needed are outstanding challenges faced by these technologies.

On the other hand, dispersive optical elements, such as prisms and gratings, can diffract light of different wavelengths in different directions. Therefore, beam steering can be achieved through chromatic dispersion by changing the input optical frequency using, a tunable laser, a broadband source, or a frequency comb as the light source. These sources themselves, however, are sophisticated and expensive. If the dispersive property of the optical element can be tuned, rather than tuning the optical wavelength, in principle beam steering can also be realized. The dispersion of an optical element depends on its material's property (e.g., for a prism) and its structure (e.g., for a grating). It is, however, impractical to tune those parameters over a wide enough range to achieve realistic beam steering.

### SUMMARY

Accordingly, the present disclosure provides systems, modules, methods, and machine-readable storage media for Frequency Angular Resolving (FAR) to address these and related challenges.

In an aspect, the present disclosure provides a system for FAR light detection and ranging (LIDAR). In an embodiment, the system comprises a transmitter comprising a source of electromagnetic radiation; a driver circuit configured to generate a drive signal at an oscillation frequency; an acousto-optical beam steering device optically coupled with the source of electromagnetic radiation and the driver circuit and configured to emit electromagnetic radiation at an emission angle as a function of the oscillation frequency; and a receiver comprising a radiation sensor optically coupled with the source of electromagnetic radiation.

In another aspect, the present disclosure provides a module comprising a first system according to any embodiment of the present disclosure, wherein the first system has a first major axis directed in a first orientation; and a second system according to any embodiment of the present disclosure, wherein the second system has a second major axis directed in a second orientation, wherein the second orientation is different than the first orientation.

In another aspect, the present disclosure provides a method of FAR, the method comprising generating electromagnetic radiation using a source of electromagnetic radiation; generating a drive signal using driver circuitry, the drive signal comprising an alternating current electrical signal at an oscillation frequency; actuating an acousto-optic deflector at the oscillation frequency using the drive signal, the acousto-optic deflector being optically coupled with the source of electromagnetic radiation; irradiating the acousto-optic deflector with a first portion of the electromagnetic radiation, thereby generating a steered beam at an emission angle, the emission angle being a function of the oscillation frequency; receiving reflected electromagnetic radiation at a radiation sensor optically coupled with the source of electromagnetic radiation, the reflected electromagnetic radiation originating from an interaction of a surface in an environment of the radiation sensor with the steered beam; generating an interference signal using the reflected electromagnetic radiation and a second portion of the electromagnetic radiation; and determining one or more characteristics of the surface using the interference signal.

In yet another aspect, the present disclosure provides a non-transitory machine-readable memory storing instructions that, when executed by a machine, cause the machine to perform operations comprising generating electromagnetic radiation using a source of electromagnetic radiation; generating a drive signal using driver circuitry, the drive signal comprising an alternating current electrical signal at an oscillation frequency; actuating an acousto-optic deflector at the oscillation frequency using the drive signal, the acousto-optic deflector being optically coupled with the source of electromagnetic radiation; irradiating the acousto-optic deflector with a first portion of the electromagnetic radiation, thereby generating a steered beam at an emission angle, the emission angle being a function of the oscillation frequency; receiving reflected electromagnetic radiation at a radiation sensor optically coupled with the source of electromagnetic radiation, the reflected electromagnetic radiation originating from an interaction of a surface in an environment of the radiation sensor with the steered beam; generating an interference signal using the reflected electromagnetic radiation and a second portion of the electromagnetic radiation; and determining one or more characteristics of the surface using the interference signal.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of subject matter disclosed herein will become more readily appreciated as the same become better understood by reference to the following detailed description, when taken in conjunction with the accompanying drawings, wherein:

FIG. 1A is a schematic illustration of a system according to an embodiment of the present disclosure;

FIG. 1B is a dispersion diagram of the acousto-optic Brillouin scattering process used in systems and methods according to embodiments of the present disclosure;

FIG. 1C is a top-down plan view illustration of a Lithium Niobate on Insulator (LNOI) chip with ten acousto-optic beam steering (AOBS) devices, according to an embodiment of the present disclosure;

FIG. 1D is a scanning microscope image of an interdigital transducer (IDT) according to an embodiment of the present disclosure;

FIG. 1E is a finite-element simulation of the AOBS process, showing light scattered into space at 300 from the surface according, to an embodiment of the present disclosure;

FIG. 2 is a schematic illustration of an AOBS device according to an embodiment of the present disclosure;

FIG. 3A is a superimposed image of a focal plane when a beam is scanned across a field of view (FOV) from 22° to 40°, showing 66 well-resolved spots, according to an embodiment of the present disclosure;

FIG. 3B is a magnified image of one spot from FIG. 3A at 38.8° where the beam angular divergence along kₓ is 0.110 (bottom inset) and along k_{y} is 1.6° (left inset), is due to the rectangular AOBS aperture, according to an embodiment of the present disclosure;

FIG. 3C is a real-space image of light scattering from the AOBS aperture of FIG. 3B where the light intensity decays exponentially from the front of the IDT (x=0), due to the propagation loss of the acoustic wave, and fitting the integrated intensity along the x-axis (bottom inset) giving an acoustic propagation length of 0.6±0.1 mm, according to an embodiment of the present disclosure;

FIG. 3D illustrates the measured frequency-angle relation when the beam is steered by sweeping the acoustic frequency according to an embodiment of the present disclosure;

FIGS. 3E-3H show dynamic multi-beam generation and arbitrary programming of 16 beams (3E) at odd (3F) and even (3G) sites, and in a sequence of the ASCII code of characters “WA” (3H) according to embodiments of the present disclosure;

FIG. 4A is a schematic illustration of a system according to an embodiment of the present disclosure;

FIG. 4B illustrates spectra of the beating signal at the receiver when the AOBS of FIG. 4A scans a beam across the FOV according to an embodiment of the present disclosure;

FIG. 4C is a frequency angular resolution light detection and ranging (FAR LiDAR) image of the object in FIG. 4A where each pixel's position and brightness are resolved from the signal's beating frequency and power, respectively, according to an embodiment of the present disclosure;

FIGS. 4D and 4E provide raw beating signal of two representative pixels of FIG. 4C according to embodiments of the present disclosure;

FIG. 5A shows a time-frequency map of the transmitted light (bottom) and received light (top), where both are chirped by a triangular waveform, the chirping rate is g=1 MHz/μs, and the frequency of the received light is upshifted by the acoustic frequency Ω/2π, according to an embodiment of the present disclosure;

FIG. 5B is a schematic illustration of the frequency-modulated continuous-wave (FMCW) signal's frequency as a function of time according to an embodiment of the present disclosure, where the frequency alternates between Ω/2π±f_{B} and the bottom panel shows measured time-frequency map of the FMCW signal. Because of the USB and LSB generated by the electro-optic modulator (EOM), the FMCW frequencies at Ω/2π±f_{B} are present all the time. Also present is the frequency component at Ω/2π, which is from the unsuppressed optical carrier and used for FAR imaging;

FIG. 5C provides spectra of FMCW signals when different acoustic frequencies (bottom: 1.6 GHz, middle: 1.7 GHz, top: 1.8 GHz) are used to steer the beam to reflectors placed at different angles and distances, according to embodiments of the present disclosure;

FIG. 5D is a 3D LiDAR image of a stainless-steel bolt and a nut, placed 8.0 cm apart from each other, acquired by combining FAR and FMCW schemes, according to embodiments of the present disclosure, where the FMCW chirping rate is g=1 MHz/μs and frequency excursion f_{E}=1 GHz, with the inset providing a photograph of the bolt and nut as the imaging objects;

FIG. 5E provides FMCW spectra of two representative points (A and B) in FIG. 5D, showing signals at Ω/2π (offset to zero frequency) and Ω/2π±f_{B} (offset to ±f_{B}), according to embodiments of the present disclosure;

FIG. 5F is a magnified view of the FMCW signals at f_{B} for points A and B;

FIG. 5G is a schematic illustration of a monolithic, multi-element AOBS system for 2D scanning and LiDAR imaging, according to an embodiment of the present disclosure;

FIG. 6 is a schematic illustration of a module according to an embodiment of the present disclosure;

FIG. 7 is a block diagram of a method according to an embodiment of the present disclosure;

FIGS. 8A and 8B provide 3D (8A) and 2D (8B) simulations of a surface-acoustic wave (SAW)-perturbed eigenmode by COMSOL, according to an embodiment of the present disclosure;

FIG. 9A illustrates a group velocity of the LNOI TE0 slab mode with different thicknesses of the LN layer, according to an embodiment of the present disclosure;

FIG. 9B illustrates a 2D optimization of the thickness of LN thin film from FIG. 9A according to an embodiment of the present disclosure;

FIGS. 9C and 9D illustrate 2D optimizations of the thickness of the BOX layer, according to embodiments of the present disclosure;

FIG. 9E illustrates a 3D optimization of the thickness of LN thin film from FIG. 9A, according to an embodiment of the present disclosure;

FIG. 9F illustrates a 3D optimization of the thickness of the BOX layer; according to an embodiment of the present disclosure;

FIG. 10 illustrates fitting result of the real-space AOBS scattering intensity, where the experimental data (gray circle) and the normalized fitted acoustic power density (Pa), guided optical modes power (Po), and radiated power (Pr) are shown, according to embodiments of the present disclosure;

FIG. 11A is the RF reflection coefficient and the electromechanical conversion efficiency of the Rayleigh mode generated by the chirped-IDT, according to an embodiment of the present disclosure;

FIG. 11B is an equivalent circuit model, according to an embodiment of the present disclosure;

FIG. 12 illustrates a fitting result of two points, according to an embodiment of the present disclosure;

FIG. 13A is a superimposed image of a focal plane of a k-space image of visible beam steering, according to an embodiment of the present disclosure;

FIG. 13B is an illustration of a measured frequency-angle relation when the beam of FIG. 13A is steered by sweeping the acoustic frequency, according to an embodiment of the present disclosure; and

FIG. 13C illustrates the beam angular divergence along kx of two selected angles, according to an embodiment of the present disclosure.

### DETAILED DESCRIPTION

Embodiments of systems, modules, methods, and machine-readable storage media for Frequency Angular Resolving (FAR) light detection and ranging (LiDAR) by acousto-optic beam steering (AOBS) are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “selecting”, “identifying”, “capturing”, “adjusting”, “analyzing”, “determining”, “estimating”, “generating”, “comparing”, “modifying”, “receiving”, “providing”, “displaying”, “interpolating”, “outputting”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such as information storage, transmission, or display devices.

The algorithms and displays presented herein are not inherently related to any particular computer or other apparatus. Various general-purpose systems can be used with programs in accordance with the teachings herein, or it can prove convenient to construct a more specialized apparatus to perform the required method steps. The required structure for a variety of these systems will appear from the description below. In addition, embodiments of the present disclosure are not described with reference to any particular programming language. It will be appreciated that a variety of programming languages can be used to implement the teachings of the disclosure as described herein.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics can be combined in any suitable manner in one or more embodiments.

### System

In an aspect, the present disclosure provides system for FAR LiDAR. In an embodiment, the system comprises a transmitter comprising a source of electromagnetic radiation; a driver circuit configured to generate a drive signal at an oscillation frequency; an acousto-optical beam steering device optically coupled with the source of electromagnetic radiation and the driver circuit and configured to emit electromagnetic radiation at an emission angle as a function of the oscillation frequency; and a receiver comprising a radiation sensor optically coupled with the source of electromagnetic radiation.

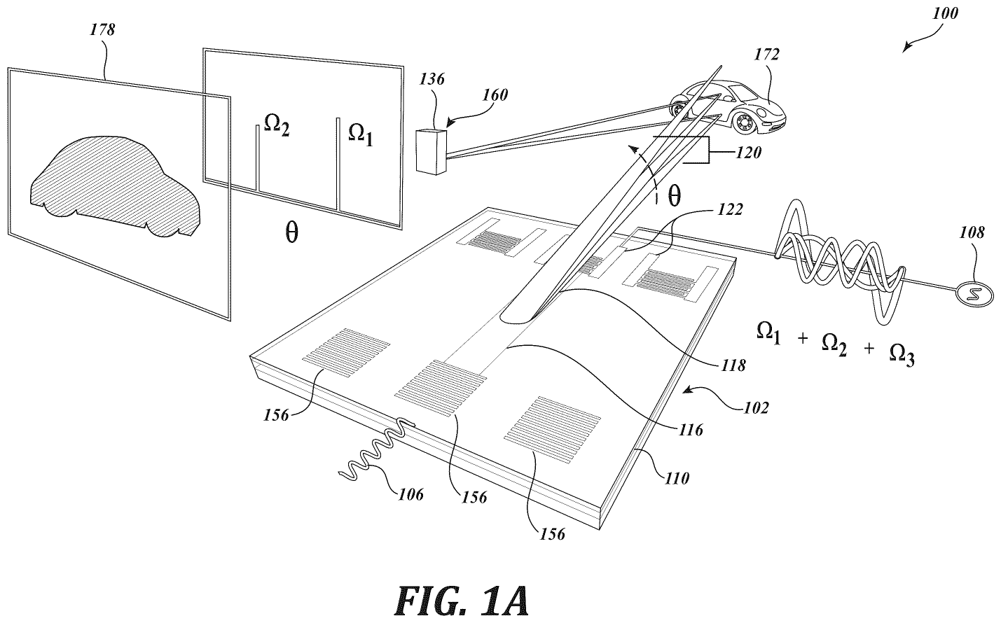

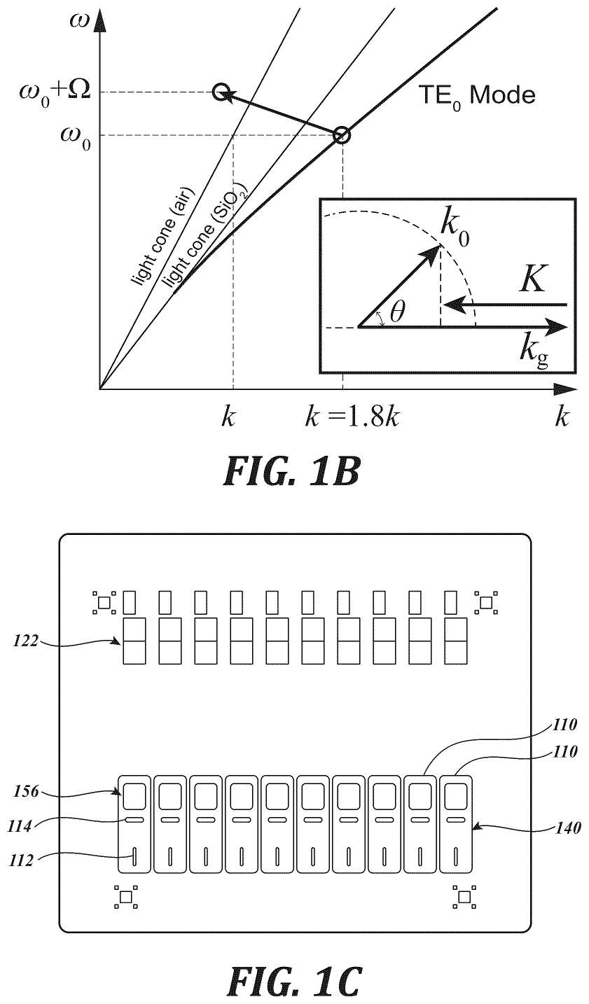

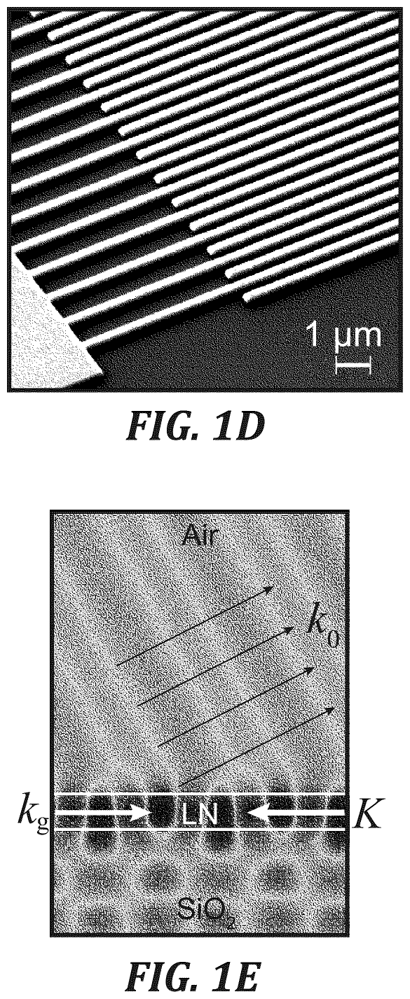

In this regard, attention is directed to FIG. 1A in which a system 100 according to an embodiment of the present disclosure is illustrated. As shown, the system 100 includes a transmitter 102 and a receiver 160.

In the illustrated embodiment, the transmitter 102 is shown to include a driver circuit 108 configured to generate a drive signal at an oscillation frequency; and an acousto-optical beam steering device 110, such as including one or more optical grating couplers 156, configured to receive electromagnetic radiation 106, such as from a source of electromagnetic radiation coupled thereto. In an embodiment and as discussed further herein, and the transmitter 102 is configured to emit electromagnetic radiation at an emission angle as a function of the oscillation frequency.

In the illustrated embodiment, the driver circuit 108 is shown generating drive signals at a plurality of oscillation frequencies. Correspondingly, the light emitted from the acousto-optical beam steering device 110 is shown emitted from the acousto-optical beam steering device 110 at a number of different angles. As discussed further herein, such angles are proportional to oscillation frequencies of the drive signals. In this regard, in the illustrated embodiment, the drive signal is a first drive signal; the oscillation frequency is a first oscillation frequency; the emission angle is a first emission angle; the driver circuit 108 is further configured to generate a second drive signal at a second oscillation frequency; and the acousto-optical beam steering device 110 is further configured to emit electromagnetic radiation at a second emission angle as a function of the second oscillation frequency, the second emission angle different from the first emission angle.

In an embodiment, the oscillation frequency is in a range from 0.1 GHz to 10 GHz. In an embodiment, the oscillation frequency is in a range from 1 GHz to 10 GHz. In an embodiment, the oscillation frequency is in a range from 1 GHz to 5 GHz. In an embodiment, the oscillation frequency is in a range from 1 GHz to 2 GHz. In an embodiment, the oscillation frequency is in a range from 1.5 GHz to 2.0 GHz.

As discussed further herein, by using an oscillation frequency in the GHz range, optical beam steering out of a plane of the AOBS device 110 is possible. Further, by using an oscillation frequency in the GHZ range, the system 100 affords sufficient bandwidth to perform frequency-modulated continuous-wave (FMCW) for coherent ranging. Moreover, by using an oscillation frequency in the GHZ range, the AOBS device 110 affords enough bandwidth to accommodate both FAR and FMCW.

In an embodiment, and as shown, the acousto-optical beam steering device 110 is further configured to emit electromagnetic radiation at the first emission angle and at the second emission angle concurrently. In this regard, the system 100 is configured to simultaneously image a variety of portions of an object 172 within a field of view of the system 100, such as at different angles relative to the acousto-optical beam steering device 110.

As shown, the steered optical beam 120 emitted at a variety of angles from the acousto-optical beam steering device 110 is emitted toward and, in some instances, reflects off of an object 172, shown here as a car 172. The steered optical beam 120 is further shown reflecting off of the object 172 and impinging upon the receiver 160, shown here to include a photodetector 136. As discussed further herein, the receiver 160 can be used and is configured to generate an image 178 based on the object 172.

In an embodiment, the receiver 160 includes a radiation sensor optically coupled with the source of electromagnetic radiation, such as the photodetector 136. In an embodiment, the radiation sensor is configured to sample incident radiation at a sampling frequency of 1 kHz or greater. In an embodiment, such a sampling frequency is configured to and suitable for imaging or otherwise detecting one or more objects, such as one or more moving objects, positioned to receive the steered optical beam 120 as the one or more moving objects move within an FOV of the system 100.

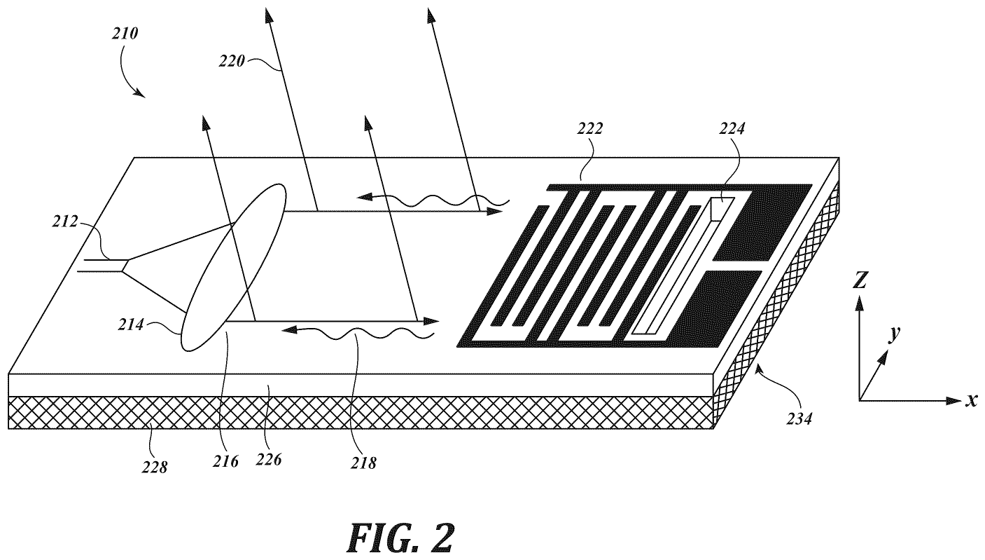

In the illustrated embodiment, the acousto-optical beam steering device 110 is configured to transmit received electromagnetic radiation through the acousto-optical beam steering device 110 as a guided optical wave 116. Additionally, in an embodiment, the acousto-optical beam steering device 110 is configured to transmit an acoustic wave 118, such as an acoustic wave 118 generated by an interdigital transducer 122 (see also FIG. 1D). As discussed further herein with respect to FIG. 2, the combination of the guided optical wave 116 and the transmitted/guided acoustic wave 118 combine to generate the steered optical beam 120 emitted from the acousto-optical beam steering device 110.

An example of an AOBS device 210 according to an embodiment of the present disclosure will now be described with respect to FIG. 2. FIG. 2 is a schematic illustration of an AOBS device 210 according to an embodiment of the present disclosure. In an embodiment, the AOBS device 210 is an example of the AOBS device 110 described further herein with respect to FIG. 1A.

In the illustrated embodiment, the AOBS device 210 is shown to include a channel waveguide 212 configured to receive electromagnetic radiation, as well as an integrated lens 214 positioned to receive the electromagnetic radiation and guide the electromagnetic radiation in the form of a guided optical wave 216 through a first layer 226 of the AOBS device 210. In this regard, the AOBS device 210 is configured to confine an acoustic wave generated by the driver circuit and an optical wave generated by the source of electromagnetic radiation in a planar waveguide structure 234 of AOBS device 210.

In the illustrated embodiment, the AOBS device 210 is shown to further include a second layer 228 shown stacked under the first layer 226.

As above, the AOBS device 210 includes a thin membrane, such as the first layer 226, or a stack of thin membranes, such as of nanoscale thickness, configured to guide both the optical and acoustic waves propagating in the plane of the AOBS device 210. In an embodiment, the membrane(s) is/are suspended in vacuum, a gas, a liquid, or in a solid medium, or on a substrate for mechanical support and heat sink. In an embodiment, the membrane comprises piezoelectric materials. In another embodiment, a layer in the stack of the membrane comprises piezoelectric material.

In an embodiment, membranes of the AOBS, such as the first layer 226 and the second layer 228, include, but are not limited to, layers comprising lithium niobate (LiNbO₃ or LN), aluminum nitride (AlN), zinc oxide (ZnO), silicon (Si) and silicon dioxide (SiO₂). By varying the materials and the thicknesses of the membranes, the AOBS device 210 performance can be further modified. For example, with a membrane of a single material suspended in air, due to the mirror symmetry of such a structure, emitted optical beams emit equally into both the upper and lower sides of the membrane, which can be undesirable if single-sided beam emission is preferred. In contrast, a stack of LN and SiO₂ membranes, for example, can break mirror symmetry, due to their different optical and acoustic properties, and suppress the optical emission into the undesired side of the device.

In an embodiment, the acousto-optical beam steering device comprises an acousto-optic deflector. In the illustrated embodiment, the AOBS device 210 is shown to further include an edge reflector 224, as well as an interdigital transducer 222.

As described further herein, the interdigital transducer 222 comprises a plurality of interdigitated electrodes disposed within the first layer 226, such as a first layer 226 comprising a piezoelectric material. In an embodiment, when the drive circuit generates a drive signal at an oscillation frequency, a guided acoustic wave 218 is also transmitted through the AOBS device 210, such as through the first layer 226. When the guided acoustic wave 218 impinges upon the guided optical wave 216, a steered optical beam 220 is emitted from the AOBS device 210 at an angle relative to a surface of the AOBS that is proportional to the frequency of the drive signal. In other words, the electromagnetic radiation is emitted at an emission angle as a function of the oscillation frequency.

In an embodiment, the AOBS device 210 is suitable for and configured to emit the steered beam into free space and steering its direction in one or two dimensions (1D or 2D), such as at a polar angle relative to a normal of an emission surface of the AOBS device 210. In an embodiment, the emission angle is in a range from −90 degrees to +90 degrees relative to a normal vector of an emission surface of the acousto-optical beam steering device.

In an embodiment, the wavelengths and the propagation directions of the acoustic waves satisfy phase-matching conditions of acousto-optic Brillouin scattering, such that the optical waves are scattered out of the plane of the device by the acoustic wave and emitted into free space. As used herein, “Brillouin scattering” refers to the scattering of optical waves by acoustic waves via the acousto-optic effect. In an embodiment, the emission direction is steered by tuning the wavelengths or frequency, as well as the propagation directions, of the acoustic waves.

In some embodiments, the AOBS device 210 can be configured as shown in FIG. 2 to steer the optical emission direction in 1D and/or 2D, by tuning the wavelength of one and two acoustic waves, respectively.

In an embodiment, optical waves are generated by a laser diode, and converted into the desired guided mode via a combination of grating couplers, waveguides, and integrated lenses. In an embodiment, the acoustic waves are generated electromechanically via interdigital transducers (IDTs) fabricated on piezoelectric membranes, such as the IDT 222 illustrated in FIG. 2. In an embodiment, the directions and wavelengths of the acoustic waves are tuned or modified by the shape, size, positioning, etc. of the IDTs and the frequencies of the radio-frequency (RF) electrical signals that drive the IDTs. In addition, in an embodiment, acoustic reflectors and absorbers are incorporated to manipulate the acoustic waves.

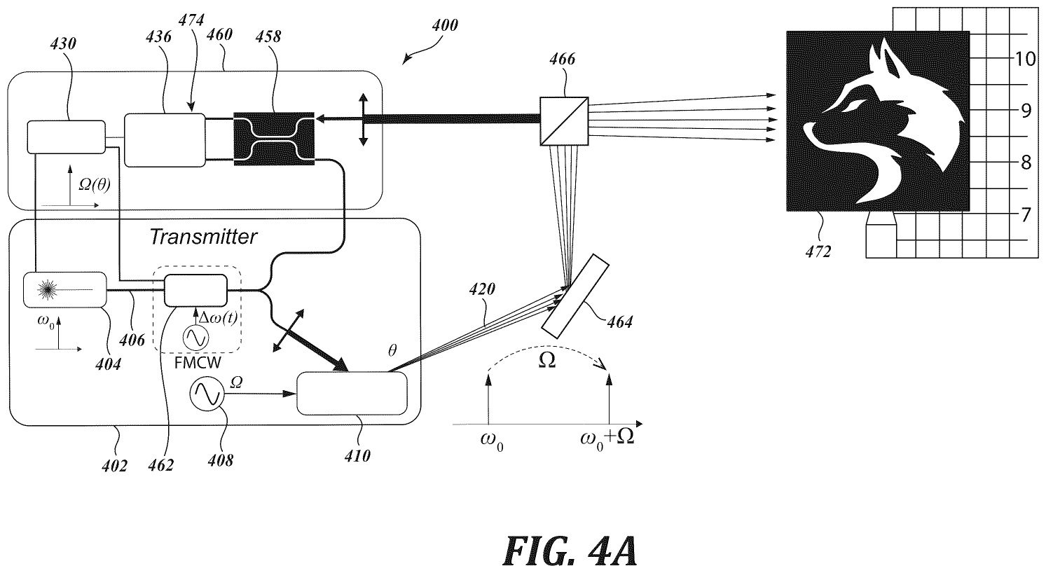

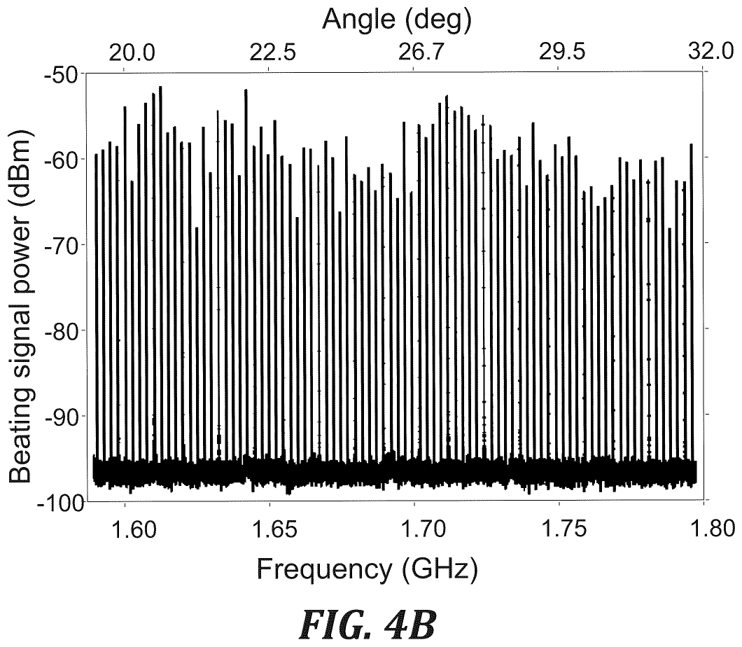

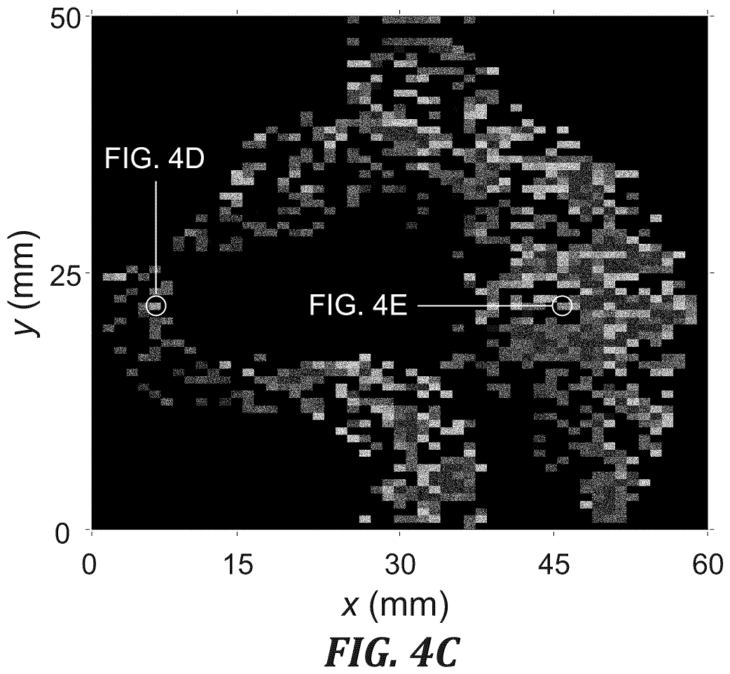

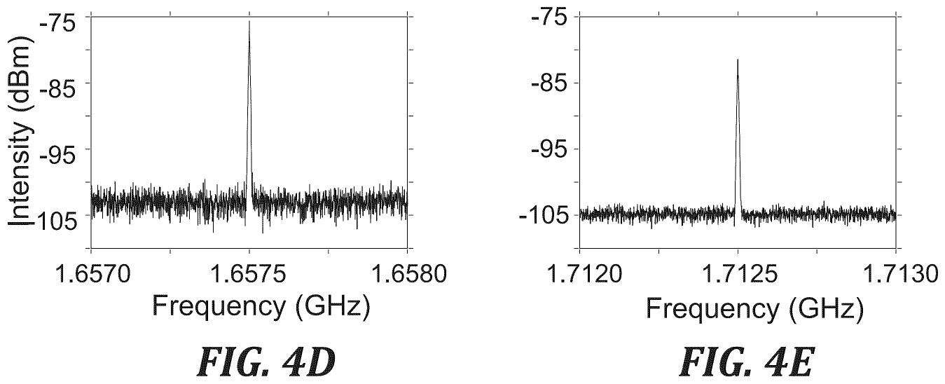

In an embodiment, the systems of the present disclosure are configured to determine a distance between the system and an object in a field of view of the system. In this regard, attention is directed to FIG. 4A which is a schematic illustration of a system 400 according to an embodiment of the present disclosure. In an embodiment, the system 400 is an example of the system 100 described further herein with respect to FIG. 1A.

As shown, the system 400 includes a transmitter 402 and a receiver 460. In the illustrated embodiment, the transmitter 402 is shown to include a source of electromagnetic radiation 404; a driver circuit 408 configured to generate a drive signal at an oscillation frequency; an acousto-optical beam steering device 410 optically coupled with the source of electromagnetic radiation 404 and the driver circuit 408 and configured to emit electromagnetic radiation 406 at an emission angle as a function of the oscillation frequency. In an embodiment, the acousto-optical beam steering device 410 is an example of the acousto-optical beam steering device 210 described further herein with respect to FIG. 2.

In an embodiment, the source of electromagnetic radiation 404 is a laser. While a laser is discussed further herein, it will be understood that other sources of electromagnetic radiation, such as non-coherent sources and/or broad-emission sources of electromagnetic radiation, are possible and within the scope of the present disclosure. In an embodiment, the electromagnetic radiation 406 comprises photons having an energy outside an energy range that is visible to humans. In an embodiment, the electromagnetic radiation 406 comprises photons having an energy in an energy range that is visible to humans.

In the illustrated embodiment, the transmitter 402 is shown to further comprise an electro-optic modulator 462 optically coupled to the source of electromagnetic radiation 404. In an embodiment, the electro-optic modulator 462 is configured to modulate a frequency of light emitted to the acousto-optical beam steering device 410. In an embodiment, modulating the frequency of light emitted to the acousto-optical beam steering device 410 comprises frequency-modulated continuous-wave (FMCW) with the electro-optic modulator 462.

As shown, the steered optical beam 420 is emitted from the acousto-optical beam steering device 410 at different angles. As discussed further herein, such different angles are based on the oscillation frequency of the drive circuit. The steered optical beam 420 is shown to impinge upon and reflect off the mirror 464 and onto the dichroic mirror before impinging on various portions of the object 472, shown here as a husky logo. The steered optical beam 420 reflects off the object 472, passes through the dichroic mirror 466, and a portion of the steered optical beam 420 is then received by the receiver 460.

In the illustrated embodiment, the receiver 460 is shown to include a radiation sensor 474 optically coupled with the source of electromagnetic radiation 404. In an embodiment, the radiation sensor 474 comprises a photodetector 436.

As shown, the receiver 460 further comprises a local oscillator 458 positioned to receive incident electromagnetic radiation reflected off an object 472 outside the system 400 and electromagnetic radiation 406 from the source of electromagnetic radiation 404. In this regard, the radiation sensor 474 is configured to receive from the local oscillator 458 the incident electromagnetic radiation reflected off the object 472 outside the system 400 and the electromagnetic radiation 406 from the source of electromagnetic radiation 404. In other words, in an embodiment, the electromagnetic radiation 406 is first electromagnetic radiation 406, and wherein the radiation sensor 474 is configured to combine the first electromagnetic radiation 406 coupled in from the source of electromagnetic radiation 404 with second electromagnetic radiation as the reflection of the first electromagnetic radiation from an environment of the system 400, such as including light reflected off the object 472.

As discussed further herein, reception of both the incident electromagnetic radiation reflected off the object 472 outside the system 400 and the electromagnetic radiation 406 from the source of electromagnetic radiation 404 generates beating of signal generated by the radiation sensor 474 based on or indicative of a distance between the system 400 and the object 472. In this regard, the system 400 is configured to determine a distance between the system 400 and the object 472.

In the illustrated embodiment, the system 400 further includes a controller 430. As shown the controller 430 is shown operatively coupled to various portions or components of the system 400, such as the photodetector 436, the source of electromagnetic radiation 404, the electro-optic modulator 462, and the acousto-optical beam steering device 410, and is configured to choreograph their operation and/or exchange signals therebetween.

The controller 430 is a functional element that choreographs and controls the operation of the other functional elements. In one embodiment, controller 430 is implemented with hardware logic (e.g., application specific integrated circuit, field programmable gate array, etc.). In yet another embodiment, the controller 430 may be implemented as a general-purpose microcontroller 430 that executes software or firmware instructions stored in memory (e.g., non-volatile memory, etc.). Yet alternatively, the controller 430 may be implemented in a combination of hardware and software and further may be centralized or distributed across multiple components.

In an embodiment, the controller 430 includes logic that, when executed, causes the system 400 to perform operations. In an embodiment, such operations include modulating with the electro-optic modulator 462 the frequency of light emitted to the acousto-optical beam steering device 410; beating with the local oscillator 458 the incident electromagnetic radiation reflected off the object 472 outside the system 400 and the electromagnetic radiation 406 from the source of electromagnetic radiation 404; measuring a frequency of the beating with the radiation sensor 474; and determining a distance between the system 400 and the object 472 outside the system 400 based on the frequency of the beating.

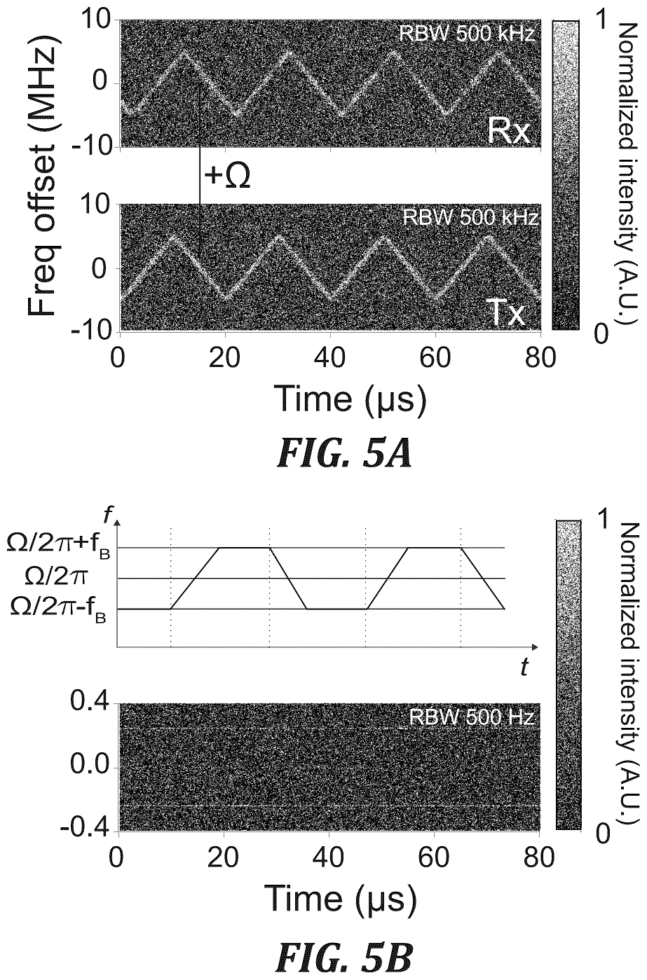

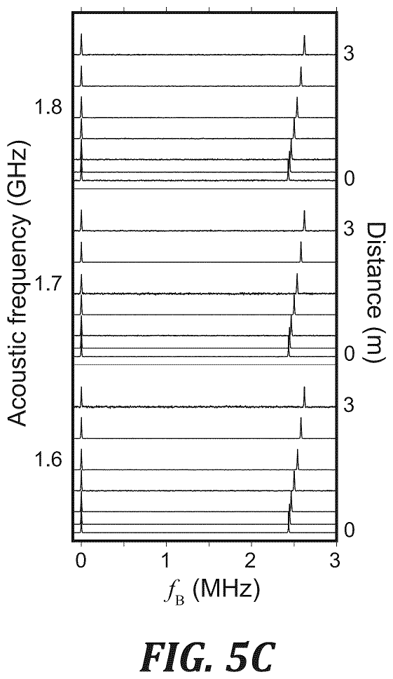

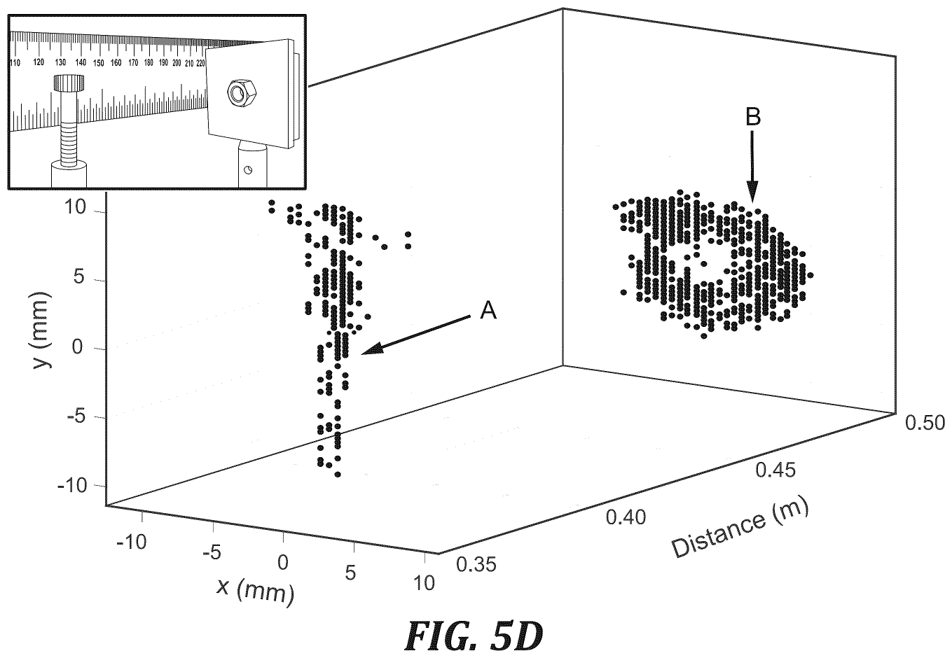

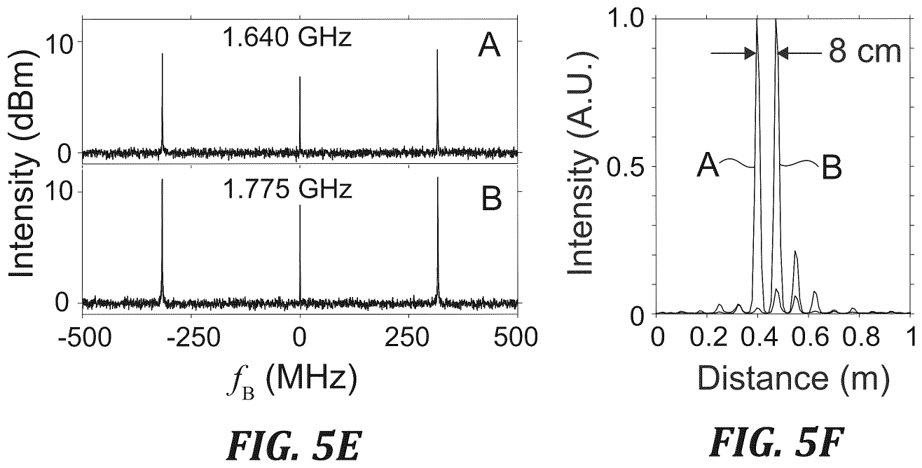

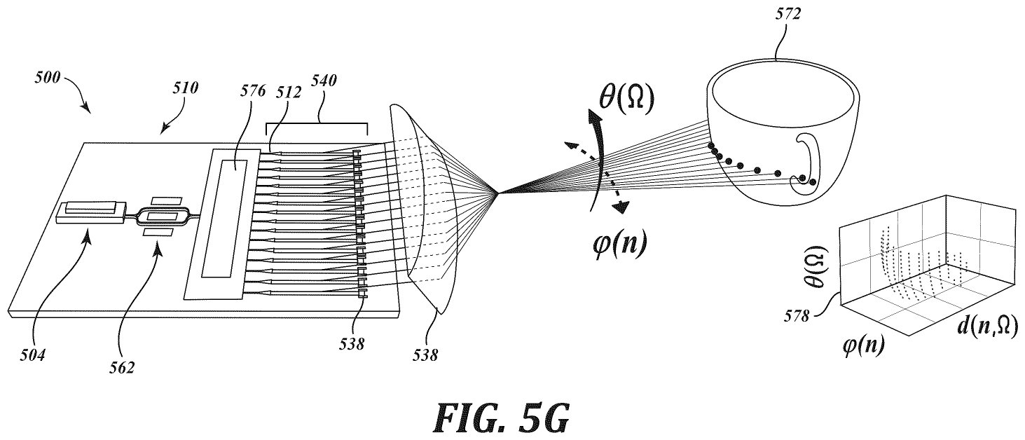

In an embodiment, the systems of the present disclosure include a plurality of acousto-optical beam steering devices. In this regard, attention is directed to FIG. 5G in which a schematic illustration of a monolithic, multi-element AOBS system 500 for 2D scanning and LiDAR imaging, according to an embodiment of the present disclosure, is illustrated.

In an embodiment, the system 500 is an example of systems 100 and 400 described further herein with respect to FIG. 1A and FIG. 4A, respectively.

As shown, the system 500 includes an AOBS device 510 including a source of electromagnetic radiation 504 configured to emit electromagnetic radiation. The system 500 is further shown to include an electro-optic modulator 562 optically coupled to the source of electromagnetic radiation 504. In an embodiment, the electro-optic modulator 562 is configured to modulate a frequency of light emitted. As discussed further herein, such frequency modulation is configured to and suitable for determining a distance of an object 572 and the system 500.

The system 500 is shown to further include a de-multiplexer 576 configured to split electromagnetic radiation generated by the source of electromagnetic radiation 504 and modulated by the electro-optic modulator 562 into several beams of light. In the illustrated embodiment, the system 500 includes several channel waveguides 512 corresponding to and in registry with the split light beams. The channel waveguides 512 are configured to emit light beams toward a plurality 540 of acousto-optical beam steering devices. As shown, the system 500 further includes a plurality of driver circuits 538 each positioned to emit acoustic waves into a path of the guided optical waves emitted from the plurality of acousto-optical beam steering devices.

As shown, each acousto-optical device of the plurality 540 of acousto-optical devices emits a steered optical beam 520 into the field of view of the system 500 and onto a portion of an object 572, shown here as a cup 572, within the field of view. As discussed further herein, the acousto-optical beam steering devices 540 are configured to emit electromagnetic radiation at an emission angle as a function of the oscillation frequency. As also discussed further herein, electromagnetic radiation having reflected off of the object 572 can be received by a receiver (not shown, see FIG. 4A) can be used to generate an image 578 of the object 572 (shown inset right).

In this regard, FIG. 5G illustrates a transmitter comprising a plurality of driver circuits, wherein driver circuits of the plurality of driver circuits are configured to generate a drive signal at an oscillation frequency; and a plurality 540 of acousto-optical beam steering devices, wherein acousto-optical beam steering devices of the plurality of acousto-optical beam steering devices are optically coupled with the source of electromagnetic radiation 504 and the driver circuit and configured to emit electromagnetic radiation at an emission angle as a function of the oscillation frequency, and wherein a first acousto-optical beam steering device of the plurality of acousto-optical beam steering devices is positioned to emit electromagnetic radiation from a first portion of the transmitter and a second acousto-optical beam steering devices of the plurality of acousto-optical beam steering devices is configured to emit electromagnetic radiation from a second portion of the transmitter.

By emitting steered optical beams 520 from various portions of the transmitter, the system 500 is configured to image different portions of the field of view of the system 500, such as along various lines within the field of view, as shown.

FIG. 1C is a top-down plan view illustration of a Lithium Niobate on Insulator (LNOI) chip with ten acousto-optic beam steering (AOBS) devices 110, according to an embodiment of the present disclosure. As shown, the LNOI chip comprises a plurality 140 of AOBS devices 110, wherein each AOBS device 110 comprises a channel waveguide 112, an integrated lens 114, an optical grating coupler 156, and an interdigital transducer 122. In an embodiment, the LNOI chip can be used in conjunction with the systems 100, 400, and 500 discussed further herein with respect to FIGS. 1A, 4A, and 5G, respectively.

### Module

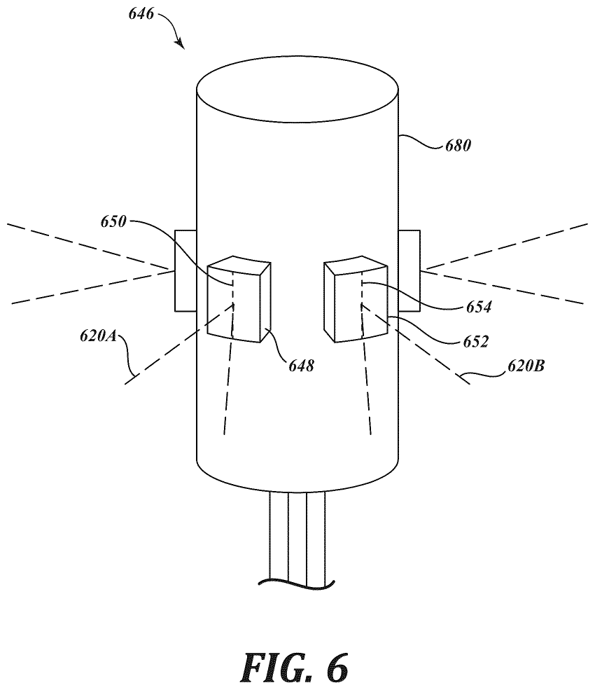

In another aspect, the present disclosure provides a module comprising two or more systems according to any embodiments described herein. In this regard, attention is directed to FIG. 6, which is a schematic illustration of a module 646 according to an embodiment of the present disclosure.

In the illustrated embodiment, the module 646 is shown to include a first system 648 disposed on a first portion of the module 646 and a second system 652 disposed on a second portion of the module 646. As shown, the first system 648 and second system 652 are coupled to a columnar structure 680, such that the first system 648 and the second system 652 face in different directions. While a columnar structure 680 is described and illustrated it will be understood that other structures or substrates coupled to multiple systems are possible and within the scope of the present disclosure.

In an embodiment, the first system 648 and the second system 652 are independently examples of any of the systems described herein, such as systems 100, 400, and 500 described further herein with respect to FIGS. 1A, 4A, and 5G. In an embodiment, the first system 648 and second system 652 are the same. In an embodiment, the first system 648 and the second system 652 are different.

As shown, the first system 648 defines a first major axis 650 directed in a first orientation. In this regard, the first system 648 is configured to emit a steered optical beam 620A in a first direction, such as along or in parallel with the first orientation. As also shown, the second system 652 defines a second major axis 654 directed in a second direction, wherein the second orientation is different than the first orientation. In this regard, the second system 652 is configured to emit a steered optical beam 620B in a direction different than the first system 648. Correspondingly, the module is configured to image a field of view that is wider or larger than a field of view of any one of the first system 648 and the second system 652 individually. While the module is shown to include a first system 648 and a second system 652, it will be understood that more than two systems are possible and within the scope of the present disclosure.

### Method

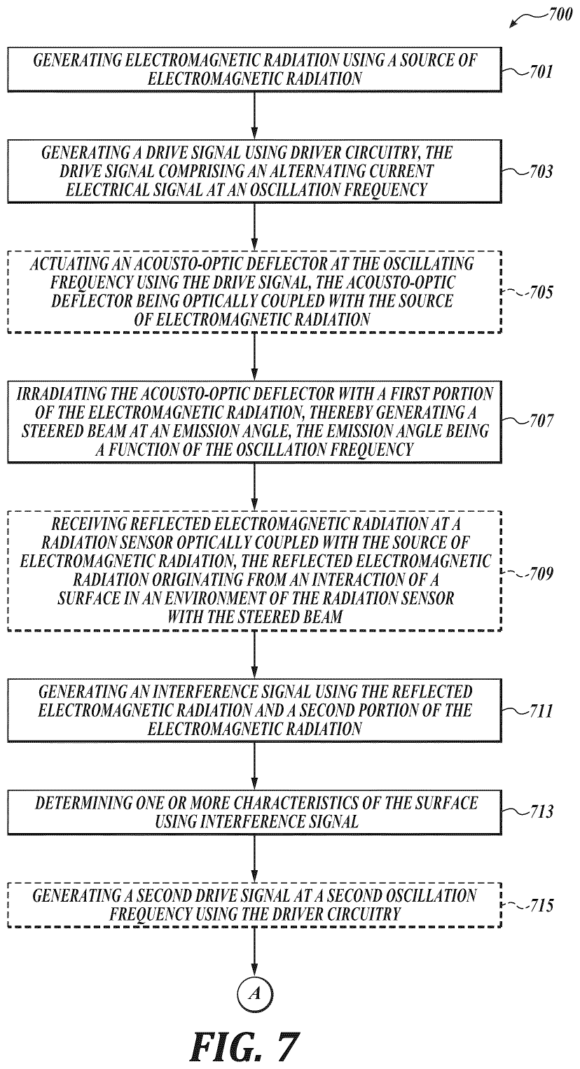

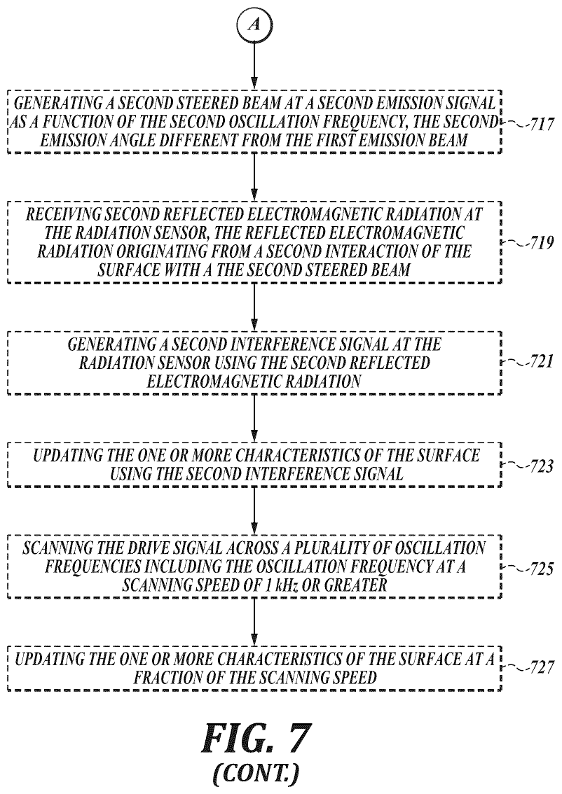

In another aspect, the present disclosure provides a method for FAR, such as FAR LiDAR. In this regard, attention is directed to FIG. 7 which a block diagram of a method 700 according to an embodiment of the present disclosure. The order in which some or all of the process blocks appear in process 700 should not be deemed limiting. Rather, one of ordinary skill in the art having the benefit of the present disclosure will understand that some of the process blocks may be executed in a variety of orders not illustrated, or even in parallel.

In an embodiment, method 700 is an example of operating or using a system according to an embodiment of the present disclosure, such as one or more of systems 100, 400, and 500 discussed further herein with respect to FIGS. 1A, 4A, and 5G, respectively.

In an embodiment, method 700 begins with process block 701, which includes generating electromagnetic radiation using a source of electromagnetic radiation, such as source of electromagnetic radiation 404. As discussed further herein, in an embodiment, the source of electromagnetic is a laser. While, lasers and laser light are discussed, it will be understood that other sources of electromagnetic radiation are possible and within the scope of the present disclosure. In an embodiment, the source of electromagnetic is configured to emit light that is visible to humans. In an embodiment, the source of electromagnetic radiation is configured to emit light that is not visible to humans.

In an embodiment, process block 701 is followed by process block 703, which includes generating a drive signal using driver circuitry, the drive signal comprising an alternating current electrical signal at an oscillation frequency. As discussed further herein, in an embodiment, generating the drive signal generates a guided acoustic wave in the acousto-optical beam steering device. In an embodiment, generating the drive signal using driver circuitry results in actuating an acousto-optic deflector at the oscillation frequency using the drive signal.

In an embodiment, process block 703 is followed by process block 705, which includes actuating an acousto-optic deflector at the oscillation frequency using the drive signal, the acousto-optic deflector being optically coupled with the source of electromagnetic radiation. In an embodiment, such actuation includes operating or powering interdigital transducers, such as with an alternating current received from the driver circuit at the oscillation frequency. In an embodiment, process block 705 is optional. In an embodiment, actuating the acousto-optic deflector at the oscillation frequency is as a result of accomplished through the drive signal.

In an embodiment, process blocks 703 and/or 705 are followed by process block 707, which includes irradiating the acousto-optic deflector with a first portion of the electromagnetic radiation. In an embodiment, process block 707 generates a steered beam at an emission angle, where the emission angle being a function of the oscillation frequency. In an embodiment, the emitted electromagnetic wave has a frequency that equals the sum of the oscillation frequency of the drive signal and the frequency of the source of electromagnetic radiation. Since the frequency of the scattered light is shifted up to ω₀+Ω, by measuring the frequency of the reflected light from an object, one can resolve an object's angular position. Based on this, an image of the object can be reconstructed from frequency domain measurement when the steered light beam is scanned in the scene by AOBS.

In an embodiment, process block 707 is followed by process block 709, which includes receiving a reflected electromagnetic radiation at a radiation sensor, such as radiation sensor 474, optically coupled with the source of electromagnetic radiation, such as where the reflected electromagnetic radiation originates from an interaction of a surface in an environment of the radiation sensor with the steered optical beam.

In an embodiment, process block 709 is followed by process block 711, which includes generating an interference signal using the reflected electromagnetic radiation and a second portion of the electromagnetic radiation. As discussed further herein, in an embodiment, the interference signal, such as a beating resulting from the combination or superposition of the first and second portions, is indicative of a distance between the surface and the radiation sensor. In an embodiment, process block 711 is optional.

In an embodiment, method 700 includes determining the angular position of the surface using the frequency of the interference signal. In an embodiment, this step follows process block 709.

In an embodiment, process blocks 707, 709, and/or 711 is/are followed by process block 713, which includes determining one or more characteristics of the surface using the interference signal. In an embodiment, such determining includes determining a distance and/or angle between the acousto-optical device, radiation sensor, and/or source of steered optical beam and the surface. In an embodiment, process block 713 is optional.

As discussed further herein, the emission angle of steered beams emitted from the AOBS devices described herein is as a function of the oscillation frequency of the drive signal. Likewise, in an embodiment, the systems and methods of the present disclosure are capable of and can include multiple drive signals, such as simultaneously include multiple drive signals, and, correspondingly, multiple emission angles. In this regard, attention is directed to process blocks 715-723.

In an embodiment, the drive signal is a first drive signal; the oscillation frequency is a first oscillation frequency; the emission angle is a first emission angle; the steered beam is a first steered beam; the reflected electromagnetic radiation is a first reflected electromagnetic radiation; the interference signal is a first interference signal; and the interaction is a first interaction. In an embodiment, process block 713 is followed by process block 715, which includes generating a second drive signal at a second oscillation frequency using the driver circuitry. In an embodiment, process block 715 is optional. In an embodiment, process block 715 occurs before, after, or simultaneously with process block 703.

In an embodiment, process block 715 is followed by process block 717, which includes generating a second steered beam at a second emission angle as a function of the second oscillation frequency, where the second emission angle is different from the first emission angle. In an embodiment, process block 717 occurs before, after, or simultaneously with process blocks 707.

In an embodiment, process block 717 is followed by process block 719, which includes receiving a second reflected electromagnetic radiation at the radiation sensor, the reflected electromagnetic radiation originating from a second interaction of the surface with the second steered beam.

In an embodiment, process block 719 is followed by process block 721, which includes generating a second interference signal at the radiation sensor using the second reflected electromagnetic radiation.

In an embodiment, process block 721 is followed by process block 723, which includes updating the one or more characteristics of the surface using the second interference signal. In an embodiment, updating the one or more characteristics can include determining a distance of a portion of the surface from the AOBS device are the second omission angle.

In an embodiment, one, some, or all of process blocks 715-723 are optional. In an embodiment, process blocks 715-723 are performed before, after, or simultaneously with process blocks 701-713,

In an embodiment, process blocks 713-723 is/are followed by process block 725, which includes scanning the drive signal across a plurality of oscillation frequencies including the oscillation frequency at a scanning speed of 1 kHz or greater. As discussed further herein, the emission angle is based on and/or proportional to the drive signal. By scanning the drive signal across the plurality of oscillation frequencies, emission angles are correspondingly scanned. As also discussed further herein, by scanning at a rate of 1 kHz or greater emission angles can be scanned to track and/or image a moving object within a field of view. In an embodiment, process block 725 is optional.

In an embodiment, process block 725 is followed by process block 727, which includes updating the one or more characteristics of the surface at a fraction of the scanning speed. In an embodiment, process block 727 is optional.

The processes explained above are described in terms of computer software and hardware. The techniques described can constitute machine-executable instructions embodied within a tangible or non-transitory machine (e.g., computer) readable storage medium, that when executed by a machine (e.g., controller 430) will cause the machine to perform the operations described. Additionally, the processes can be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

### EXAMPLES

### Example 1: Device Fabrication

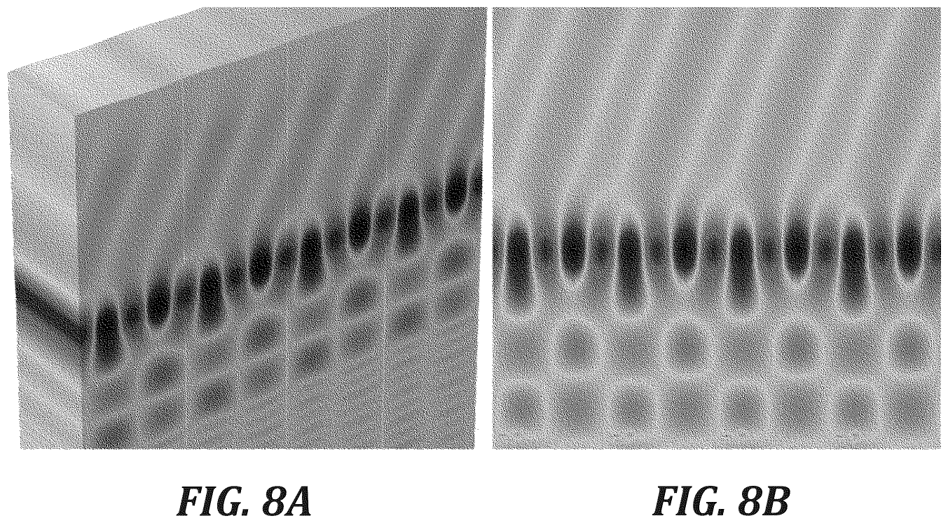

The AOBS devices were fabricated on an x-cut lithium niobate on silicon (LNOI) substrate with 300 nm thick lithium niobate, 2 μm thick silicon dioxide on 500 μm silicon substrate. The optical grating coupler was patterned with electron-beam lithography (EBL) using negative resist hydrogen silsesquioxane (HSQ). The IDT was then patterned with EBL using a positive resist (ZEP-520), followed by a lift-off process of 180 nm thick aluminum film. The process flow is shown in FIG. 8. The IDT has periods chirped from 1.45 to 1.75 μm and a total of 45 pairs of electrode fingers for better impedance matching.

### Example 2: Optical Characterization Setup

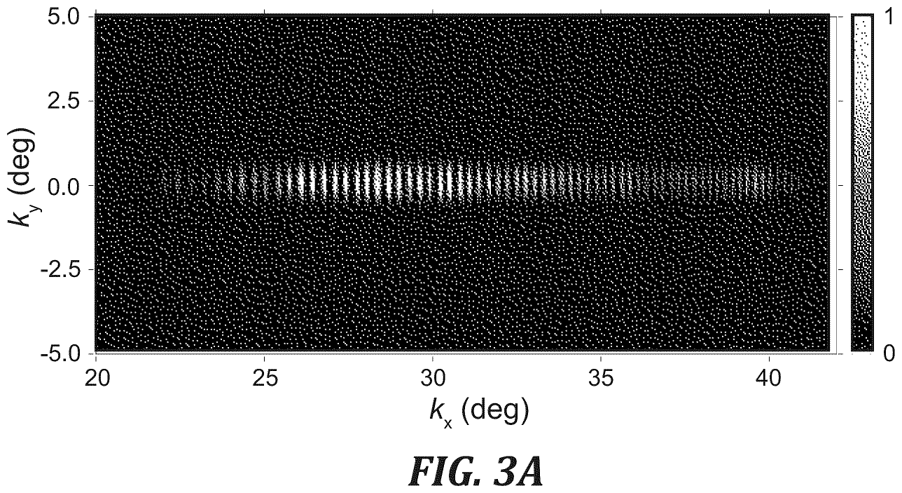

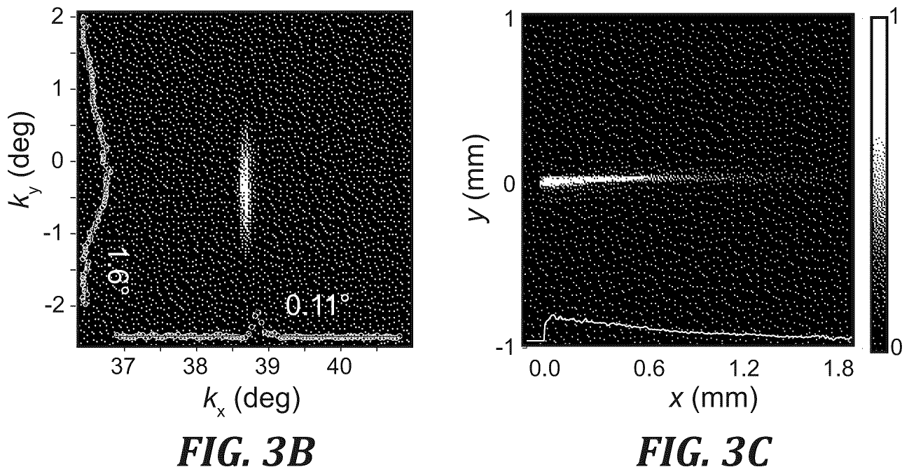

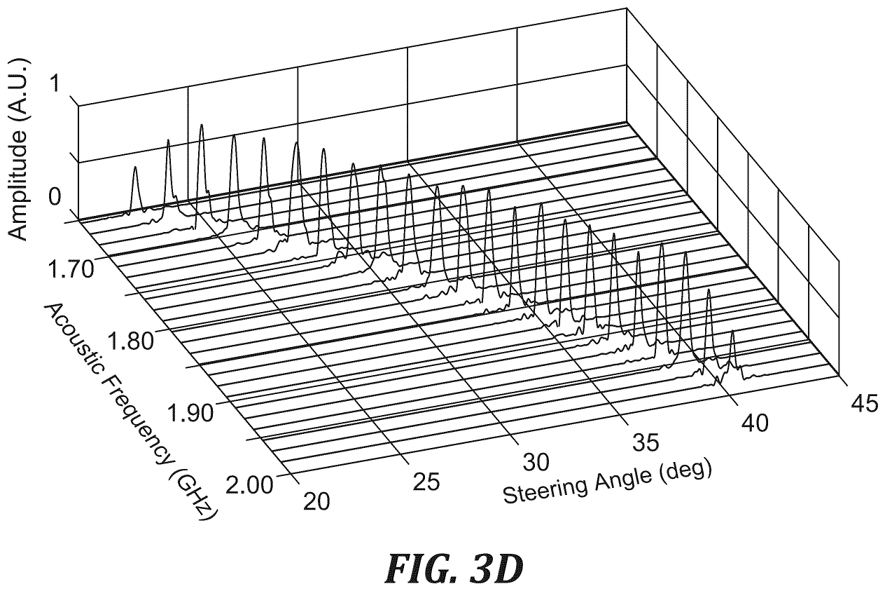

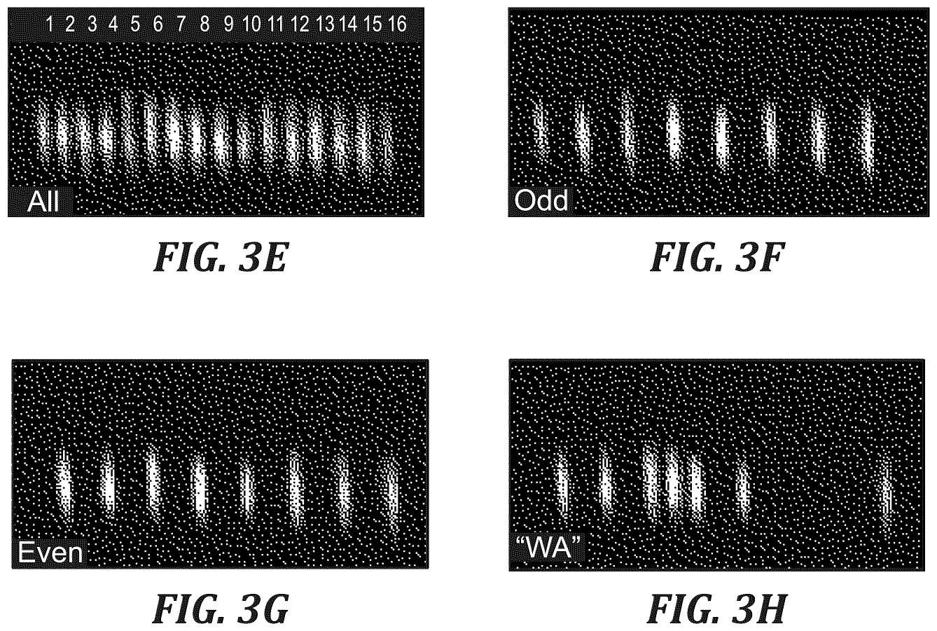

The beam steering patterns and profiles shown in FIG. 3 were captured. An infrared camera (Xenics Xeva 320) was used to capture the images. For real-space imaging of the beam profile at the ABOS aperture (FIG. 3C). For k-space imaging of the beam profiles across the whole FOV, a 10× near-IR objective was used to project the steered beam onto the Fourier plane, where the patterns were captured by a 4f imaging system with tunable magnification. To calibrate k-space measurement, a collimated laser beam was directed to a reflective diffractive grating (Thorlabs GR1325) at an incident angle θi and the diffraction pattern was measured and used to calibrate the system following the standard grating equation.

### Example 3: Coherent Receiver Setup

The FAR and FMCW measurements shown in FIGS. 4 and 5 were achieved with a coherent receiver in a configuration as shown in FIG. 4A. The output of a diode laser (Thorlabs ULN15PC) was first modulated by an EOM (Thorlabs LNP6118) to generate two modulation sidebands, which were chirped for FMCW measurement (unneeded for the FAR measurement). The EOM was driven by an AWG (Tektronix AWG70000B) and an amplifier. 1% of the optical power was tapped out to be used as the local oscillator in the receiver, and the remaining power was coupled into the AOBS, which was driven by an amplified microwave source, either from an AWG or a vector network analyzer (VNA) (Keysight E8362B) for multi-beam or single beam steering, respectively. The reflected light from the object was collected by a collimator, coupled into a single mode fiber, amplified by a low-noise erbium-doped fiber amplifier (Pritel LNHP-PMFA-23), and fed into a 50/50 fiber coupler, where it beats with the local oscillator. The beat signal was measured with a balanced photodetector (BPD) (Thorlabs PDB482C-AC), whose output signal was digitalized and analyzed with a spectrum analyzer (Tektronix RSA5100B).

### Example 4: Discussion

Nature provides a means to generate a dynamically tunable index grating-acoustic waves propagating in a material mechanically undulate its refractive index and thus produce a moving index grating. For a given material, the spatial period of this grating is determined by the acoustic wavelength in the material, and the phase contrast is controlled by the acoustic intensity. These dispersive properties can be conveniently tuned by controlling the acoustic wave frequency and power. This moving grating can scatter light through Brillouin scattering, which is an inelastic scattering process of light by the acoustic waves. Given the acoustic frequency (Ω) and phase velocity (ν), momentum conservation (or equivalently, phase-matching condition) determines the angle of light scattering, while energy conservation dictates that the frequency of the scattered light is shifted by the amount of the acoustic frequency. These principles have been utilized in various types of acousto-optic devices, such as acousto-optic deflectors, switches, frequency shifters, and filters. Conventional acousto-optic devices use bulk crystals and MHz frequency acoustic waves to realize a large optical aperture and achieve a high angular resolution, but deflect light only by a small angle.

A paradigm shift is the advancement of guided-wave acousto-optic devices, which confine both optical and acoustic waves in planar waveguiding structures, leading to significantly enhanced light-sound interaction and consequently acousto-optic performance and efficiency. In those devices, the scattering of light mainly remains in the plane of the 2D waveguide.

If the acoustic frequency is sufficiently high, the acoustic wavenumber K=Ω/ν will be large enough such that it can scatter the counter-propagating optical waveguide mode into the light cone, thereby steering a beam into free space. FIG. 1A schematically illustrates this effect, which is the base of the acousto-optic beam steering (AOBS) described herein.

The dispersion diagram in FIG. 1B depicts the phase-matching condition of AOBS: k₀ cos(θ)=k_{g}−K, where k_{g} is the guided optical mode wavenumber, k₀=ω₀/c is free space optical wavenumber, and θ is the scattering angle measured from the surface of the waveguide. At the same time, the scattered light frequency is shifted up from ω₀ to the anti-Stokes sideband at ω₀+Ω. Therefore, we can find a frequency-angular relation (Ω−θ) for AOBS:

$$cos ( θ ) = \frac{{k}_{g} - K}{{k}_{0}} = {n}_{e} - ( \frac{c}{{ω}_{0} v} ) Ω \qquad ( 1 )$$

where nₑ=k_{g}/k₀ is the effective mode index of the waveguide mode. The simple relation (1) has two implications. First, the light scattering angle θ is controlled by the acoustic frequency Ω such that beam steering out of the substrate (i.e., cos(θ)<1) can be achieved with Ω/2π in the GHz range for typical planar waveguides (e.g., with nₑ>1.5) and near-infrared light. Second, since the frequency of the scattered light is shifted up to ω₀+Ω, by measuring the frequency of the reflected light from an object, one can use equation (1) to resolve the object's angular position θ. Thereby, an image of the object can be reconstructed from frequency domain measurement when the steered light beam is scanned in the scene by AOBS. Combining these two essential principles, we propose the frequency-angular resolving (FAR) LiDAR, as illustrated in FIG. 1A, which consists of a transmitter using AOBS as the beam scanner and a coherent receiver to measure the frequency of the reflected light. FAR LiDAR has several advantages. First, since the angular position of the object is “labeled” by the frequency of the reflected light, the receiver can determine the object's position without a priori knowledge of the outgoing beam angle. This novel scheme thus allows the transmitter and the receiver to be separated and use different optical apertures in a bistatic configuration and operated asynchronously, affording much flexibility in designing the receiver to improve signal-to-noise ratio and detection speed. Second, AOBS uses a single microwave drive to excite the acoustic wave, whose frequency determines the steering angle. Random access is achieved by changing the drive frequency arbitrarily within the system bandwidth. Third, AOBS uses coherent acoustic waves so that multiple tones of different frequencies can copropagating in the device to scatter light into multiple directions simultaneously. Therefore, parallel scanning and detection of multiple beams can be achieved. Finally, since the acoustic frequency used in the FAR LiDAR is in the GHz range, the system affords sufficient bandwidth to perform FMCW for coherent ranging. Combining FAR and FMCW, full 3D imaging will be achieved. In this paper, we demonstrate all of the above-mentioned capabilities with a prototype FAR LiDAR system based on chip-scale AOBS devices.

We build AOBS devices using the lithium niobate on insulator (LNOI) platform (330 nm thick LN layer and 2 μm buried oxide). FIG. 1C shows an image of an array of ten AOBS devices fabricated on an LNOI chip. Each AOBS device has a very simple construction consisting of only two components. On one end, an interdigital transducer (IDT) made of 180 nm aluminum film, as shown in FIG. 1D, is patterned and used to electromechanically excite acoustic waves utilizing LN's strong piezoelectricity. On the other end, an optical grating coupler is patterned in hydrogen silsesquioxane (HSQ) electron beam resist. The grating couples light from a laser to the transverse-electric field (TE) mode of the planar waveguide formed by the LN layer. The space between the IDT and the grating coupler, which is w=100 μm wide and l=2 mm long, is the AOBS' nominal beam steering aperture. The acoustic waves are generated by the IDT and propagate to fill this aperture, scattering the counter-propagating light coupled in from the grating coupler. The dispersion relation of the TE mode (FIG. 1E) at 1.55 μm optical wavelength is simulated and plotted in FIG. 1B, from which we can calculate the required acoustic wavenumber from equation (1). At a given frequency, the acoustic wavelength (A) and wavenumber (K) are determined by the period of the IDT and the phase velocity (ν) of the acoustic mode that is excited. Of interest for the AOBS purpose is the Rayleigh type mode, which is confined in the LN layer and thus efficiently interacts with the TE mode. To achieve a large range of steering angles, that is, a large angular FOV, the AOBS device needs to have a widely tunable acoustic frequency. To this end, a broadband IDT design is employed with chirped periods to achieve Δf=350 MHz bandwidth at a central frequency of 1.8 GHz. The simulation results in FIG. 1E show that the TE mode is scattered from the chip surface into free space at an angle (θ) of 30° with a theoretical FOV of 20°. Another metric for acousto-optic devices is the number of resolvable spots (equivalently, the time-bandwidth product), which is given by N=Δf·τ. τ=l/ν is the acoustic transit time across the aperture of length l, where ν=3,100 m/s is the phase velocity of the Rayleigh mode. Therefore, a theoretical value of N=226, comparable to bulk acousto-optic devices, despite a much smaller aperture because of a much larger absolute bandwidth.

The beam steering results of the AOBS device are shown in FIG. 3A-3H. A fiber-coupled, near-IR diode laser is used as the light source. A CCD camera is placed at the focal plane of a lens to image the steered beam in the momentum-space (k-space). FIG. 3A shows the superimposed images captured by the camera, showing 66 spots when the beam is scanned in angles of 22° to 40° (18° FOV) by sweeping the frequency of the microwave source that drives the IDT. The variation in the intensity among the spots is attributed to the uneven electromechanical conversion efficiency within the bandwidth of the IDT. FIG. 3B shows the detailed profile of one spot, which has an angular divergence of 0.11° (full-width half-maximum (FWHM)) along the kₓ-axis and 1.6° along the k_{y}-axis. The elliptical spot shape is diffraction-limited by the rectangular acousto-optic aperture. The average kₓ-axis angular divergence of the beams across the FOV is 0.120 so the number of resolvable spots along is thus N=150, lower than the theoretical value. FIG. 3C shows the real-space image of light scattering from the AOBS aperture. The intensity of scattered light appears to decay from the front edge (x=0) of the IDT, where the acoustic wave intensity is the highest, toward the grating coupler. Since the optical propagation loss of the TE mode is expected to be low, fitting the results in FIG. 3C with a model reveals that the acoustic wave suffers a high loss with a propagation length (1/e) of ˜0.6±0.1 mm, which reduces the effective AOBS aperture length from the nominal length. In comparison, acoustic waves of similar frequencies in bulk LiNbO₃ have a propagation length of centimeters. The relatively high acoustic loss can be attributed to the bonding interfaces of the LNOI wafer and the leakage to the substrate. By using a free-standing LN membrane or LN on sapphire substrates where the acoustic wave is confined in the LN layer, the acoustic loss can be significantly reduced. The highest overall beam steering efficiency in FIG. 3A is determined to be 2.8% at 30°, based on fitting the results in FIG. 3C with a model, when 20 dBm microwave power is applied to drive the IDT. The limiting factors of the current device in efficiency include the broadband IDT's low electromechanical conversion efficiency of only ˜5.1% and the small effective aperture size due to high acoustic loss. Our simulation (FIG. 1E) shows that if the effective aperture can be increased to 5 mm, the steering efficiency can be improved to 20% using a moderate microwave power of 20 dBm.

The AOBS frequency-angular relation θ(Ω) described by Equation (1) is measured and plotted in FIG. 2D, which shows the beam steering angle as a function of a single-tone acoustic frequency. This measurement provides the calibration needed for using the AOBS in FAR LiDAR. In addition, the coherence of the AOBS process also allows multiple tones of acoustic waves to co-propagate in the aperture. Each tone scatters the light into a different angle and thus together they generate multiple beams simultaneously. Each beam is independently controlled in phase and amplitude by the corresponding RF drive. Such multi-beam steering capability is demonstrated in FIGS. 3E-3H. We drive the IDT with multi-tone waveforms that consist of 16 equally spaced frequency components to generate an array of 16 beams (FIG. 3E). The waveforms are synthesized by an arbitrary waveform generator (AWG). To demonstrate arbitrary programming of the beam array with random access, in FIGS. 3F-3H, respectively, we show beams generated at even and odd sites, and a sequence representing the ASCII code of “WA”. It is worth noting that the multi-beam steering capability of acousto-optic deflectors plays a role in neutral atom and trapped ion quantum computing for performing parallelized quantum gates. The LNOI platform can support a broad optical spectral range, including those used in atom and ion quantum computing. As provided in the Examples below, the present disclosure provides results of visible band AOBS with performance similar to the infrared.

It is further demonstrated herein LiDAR imaging using the FAR principle of AOBS. FIG. 4A shows the schematic of the FAR LiDAR system. In the transmitter, an AOBS device steers and scans the laser beam at an angle θ(Ω) toward the object in the far field. If FMCW ranging is performed, an electro-optic phase modulator (EOM) is used to modulate the laser light to generate a chirped source. Without FMCW, the frequency of the steered beam is shifted by AOBS to the anti-Stoke sideband at ω₀+Ω. To resolve this frequency shift, we use the coherent receiver scheme. The receiver taps 1% of the laser source as the local oscillator (LO). The reflected light from the object is collected with a lens and coupled into a 50/50 fiber coupler, where it combines with the LO. A balanced photodetector (BPD) is used to detect their beating signal at frequency Ω, which is digitized and analyzed. FIG. 4B shows the various beating signals measured at the receiver using a spectrum analyzer when the AOBS scans the beam across different angles. Based on Equation (1) and using the measured frequency-angular relation θ(Ω) in FIG. 3C, it is possible to transform the beating frequency Ω to the angle θ′ of the reflected light and reconstruct an image of the object. Since the linewidth of the beating peak is only ˜100 Hz, the angular resolution is diffraction limited. Herein imaging is demonstrated using a cutout of a husky dog logo made of a retroreflective film with a size of 60 mm×50 mm and placed at 1.8 meters from the LiDAR. Since AOBS scans the beam in the horizontal dimension, a galvo mirror is used to scan in the vertical direction. The acquired LiDAR image is shown in FIG. 4C. The position of each pixel in the image is resolved from the corresponding beating frequency, and the brightness from the signal intensity. FIGS. 4D and 4E show the beating signals of two pixels in the image, centered at 1.6575 GHz and 1.7125 GHz, respectively. We note an advantage of the FAR scheme demonstrated here. After the initial calibration of the θ(Ω) relation (FIG. 3D), the receiver works independently from the transmitter to determine the angular position from the beating frequency. Because of this, the receiver does not need to share the optical aperture with the transmitter, so it has the freedom to use a much larger aperture, collecting reflected light more efficiently and improving detection sensitivity. In contrast, in other scanning LiDAR schemes, to retrieve the angular information the receiver needs to share the aperture and work synchronously with the transmitter, and thus faces limitations. We also measured the point-to-point switch speed of AOBS, which determines the imaging speed. The measured rising time is 1.5 μs, likely limited by the electronic system as it is much longer than the fundamental limit of the acoustic wave transit time ˜0.19 μs in the effective aperture.

To achieve 3D imaging, the present disclosure employs FMCW ranging to the FAR LiDAR to measure the depth of the object. FMCW is a coherent ranging technique that is advantageous over incoherent techniques such as pulsed time-of-flight. Thanks to the use of GHz frequency acoustic waves, the AOBS affords enough bandwidth to accommodate both FAR and FMCW. To chirp the optical frequency, we drive the EOM (FIG. 3A) at frequency Aw, which creates two sidebands at ω₀±Δω. Both can be used as the chirped source by modulating the drive frequency with a triangular waveform Δω(t) at a chirping rate g=d(Δω/2π)/dt. The receiver measures the beating frequency f_{B} between the local reference signal and the reflected light to determine the distance of the object: d=cf_{B}/2g. FIG. 5A shows the time-frequency map of the chirped optical source at the transmitter, which is the reference signal, and the reflected optical signal from a reflector at the receiver. For clarity, both signals are offset to the baseband. Note that the reflected signal has an additional frequency offset of the acoustic frequency Ω/2π and has a delay due to the time-of-flight 2d/c. The beating frequency between the reference signal and the reflected signal thus alternates between Ω/2πf_{B} with time (FIG. 5B, upper panel). However, since both sidebands are involved and their frequencies are chipped in opposite directions, the beating signal at the receiver has frequencies at both Ω/2πf_{B} all the time. The frequency Ω/2π is also present due to the unsuppressed carrier. This is shown in the measured time-frequency map in FIG. 5B (lower panel). FIG. 5C shows the spectra of the beating signal when three different acoustic frequencies Ω/2π are used to steer beams in different directions, where they are reflected by reflectors placed at different distances up to 3 meters. The spectra contain a frequency component at the acoustic frequency Ω/2π, which is used for FAR imaging, and a frequency component at Ω/2π+f_{B} (Ω/2π−f_{B} is not shown) with an MHz beating frequency f_{B}, which increases with the reflector's distance. Therefore, by resolving all these frequency components, simultaneous FAR and FMCW measurements and a full 3D LiDAR image can be acquired in one scan. This is what we demonstrate in FIG. 4D, where we image a pair of ½-20 stainless steel screw bolt and nut (inset, FIG. 5D) placed 0.5 m from the LiDAR. The acquired point cloud image in FIG. 5D clearly shows the shape of the two objects separated by 8 cm in the depth direction. Each point is reconstructed from the frequency-domain spectrum of the FAR+FMCW signal. The chirping rate used is 1.0 MHz/μs with a frequency excursion f_{E}=1 GHz. FIG. 5E shows the raw data for two points, A on the bolt and B on the nut. FIG. 5F shows the detail of the FMCW beating signals in FIG. 5E. The distance measurement resolution is 7.5 cm, which can be improved by increasing f_{E}.

In this regard, we have demonstrated 3D imaging using a novel FAR and FMCW LiDAR scheme enabled by an AOBS device, which harnesses the physics of Brillouin scattering to achieve beam steering controlled by only one RF source. AOBS uniquely performs the transformation between the angle and frequency of the steered light, enabling imaging in the frequency domain. The single AOBS prototype demonstrates a FOV of 18°, an angular resolution of 0.12°, and an electronics-limited switching speed of 1.5 μs, which corresponds to an imaging rate of 0.67 megapixels/second. If using 16 channels (FIG. 3E) for LiDAR imaging, one AOBS device provides an imaging rate of more than 10 megapixels/second, which can be improved to much higher with faster electronics such as ASCI or FPGA.

With one IDT, each AOBS scans the beam in one dimension. 2D scanning can be achieved with an array of AOBS devices (FIG. 1C), each scanning independently to cover the horizontal dimension, as illustrated in FIG. 5G. Advanced IDT designs, such as single-phase unidirectional transducers (SPUDTs), can not only increase the acoustic bandwidth and thus the AOBS FOV, but also afford much higher electromechanical conversion efficiency and unidirectional acoustic wave generation to increase beam steering efficiency. Furthermore, a few AOBS devices with different central acoustic frequencies can be combined to cover an even larger FOV. The steering efficiency of the current device is mainly limited by the relatively high acoustic loss which reduces the effective AOBS aperture to less than 1 mm. By using higher quality material platforms, the acoustic loss can be reduced so that a much longer aperture can be achieved to significantly improve the efficiency based on our simulation. Moreover, the electro-optic modulator needed for FMCW can also be co-integrated on the LN platform (FIG. 5G), making a fully monolithic transmitter module. With these improvements and innovations, a multi-element, chip-scale AOBS system can afford efficient 2D beam steering covering a large FOV. The combined advantages of simple device structures, simple beam steering control, frequency domain resolving capability, miniature form factor, and low cost make the demonstrated AOBS-based LiDAR a promising technology for a wide range of applications, ultimately making LiDAR a commodity technology with widespread adoption in automation, industrial sensing, and consumer electronics for virtual and augmented reality.

### Example 5: Perturbation Theory of Acosuto-Optic Scattering in a Planar Waveguide

In the Brillouin scattering process, the modulation of the material's refractive index by the acoustic wave is relatively small compared to fabricated photonic structures. The refractive index change induced by the photoelastic effect (Δn/n) is typically on the order of 10-4 or less while the mechanically induced geometry displacement is several orders smaller than the optical wavelength. To simulate the AOBS process with the finite-difference time-domain (FDTD) method, a large number of computational cells with sub-wavelength dimensions are required, making the calculation very inefficient. However, the AOBS process can be better modeled by a semi-analytical method using perturbation theory, where the acousto-optic interaction can be viewed as a perturbation to the light field.

From [1], the Maxwell master equation can be described as,

$$∇ \times ∇ \times E ( r ) = {ω}^{2} {μ}_{0} ε ( r ) E ( r )$$

By choosing operators, Θ=∇×∇×, \hat{ε}=ε(r), the master equation of the electrical field can be treated as the generalized eigenvalue problem,

$$Θ \vert E 〉 = {ω}^{2} {μ}_{0} \hat{ε} \vert E 〉$$

where the eigenvector E(r) is the spatial distribution of the waveguide mode and the eigenvalue co is the mode frequency.

Then the perturbation to the permittivity operator is introduced as follows,

\hat{ε}→ε₀+λε₁

Similar to the treatment of perturbation theory in quantum mechanics [2], the new eigenvector and eigenvalue can be expanded as Maclaurin power series,

$$\begin{matrix}\vert E 〉 = \vert {E}_{0} 〉 + λ \vert {E}_{1} 〉 + … \\ ω = {ω}_{0} + λ {ω}_{1} + …\end{matrix}$$

where the first order equation is,

$$Θ \vert {E}_{1} 〉 = {ω}_{0}^{2} {μ}_{0} {ε}_{1} \vert {E}_{0} 〉 + {ω}_{0}^{2} {μ}_{0} {ε}_{0} \vert {E}_{1} 〉 + 2 {ω}_{0} {ω}_{1} {μ}_{0} {ε}_{0} \vert {E}_{0} 〉$$

By integrating the equation with the unperturbed eigenmode E0, the perturbation of the eigenfrequency ω1 (the frequency shift from the unperturbed mode E0) can be described as the following,

$${ω}_{1} = - \frac{{ω}_{0}}{2} \frac{〈 {E}_{0} \vert {ε}_{1} \vert {E}_{0} 〉}{〈 {E}_{0} \vert {ε}_{0} \vert {E}_{0} 〉}$$

If we define an equivalent polarization current density as J=−iω0ε1E0, ω1 can be expressed with the perturbation-induced current density J,

$${ω}_{1} = - \frac{i}{2} \frac{〈 {E}_{0} \vert J 〉}{〈 {E}_{0} \vert {ε}_{0} \vert {E}_{0} 〉}$$

In an AOBS device, the surface acoustic wave (SAW) forms a moving grating to scatter the guided optical mode into radiative modes. Therefore, the imaginary part of co corresponds to the propagation loss of the guided mode attributed to the acousto-optic scattering. Thus, the scattering rate (propagation loss) is α=2Im(β)=2Im(ω₁)/ν_{g}, where β and ν_{g} are the wavenumber and group velocity of the guided mode, respectively.

The moving grating generated by the acoustic wave has two contributions: the geometry deformation at the boundary of the waveguide, and the refractive index changing induced by the photoelastic effect. Therefore, the SAW-induced equivalent polarization current density can be divided into two parts,

$$J = {J}_{mb} + {J}_{pe}$$

where J_{mb} and Jₚₑ are the polarization current produced the moving boundary effect and the photoelastic effect, respectively.

According to [1], we can find that the moving boundary induced current density due to the displacement field u is,

$${J}_{mb} = - i {ω}_{0} u \cdot n ( {Δε}_{12} {E}_{‖} - {εΔε}_{12}^{- 1} {D}_{⊥} ) δ ( z )$$

where the Dirac delta function δ(z) is to obtain a surface integral with z-direction along the surface normal, Δε12=ε1−ε2 represents the permittivity difference across the boundary, ε1−1 is the impermeability that Δε12−1=ε1−1−ε2−1, E_{∥} is the parallel component of E0 to the interface, and D_{⊥} is the perpendicular component of D=εE0. From this expression, the surface integral [symbol] E₀|J [symbol] only has terms proportional to |E_{∥}|² and |D_{⊥}|², both of which are continuous across the interface, and can be numerically calculated.

The photoelasticity induced current density Jpe can be expressed as,

$${J}_{pe} = - i {ω}_{0} {Δε}_{pe} {E}_{0}$$

where Δεpe is the permittivity changing inside the waveguide due to the photoelastic effect.

Such effect can be expressed as the change of the permittivity induced by the strain

$${Δε}_{ij} = - \frac{{ε}_{i} {ε}_{j}}{{ϵ}_{0}} {\sum }_{kl} {p}_{ijkl} {S}_{kl}$$

$${S}_{kl} = \frac{1}{2} ( \frac{\partial {u}_{k}}{\partial {x}_{l}} + \frac{\partial {u}_{l}}{\partial {x}_{k}} )$$

where pijkl are dimensionless elasto-optic coefficients and u is the displacement field.

Therefore, the overall perturbed current density is as follows,

$$J = {J}_{mb} + {J}_{pe} = - i {ω}_{0} [ u \cdot n ( {Δε}_{12} {E}_{‖} - {εΔε}_{12}^{- 1} {D}_{⊥} ) δ ( z ) - \frac{{ε}_{i} {ε}_{j}}{2 {ϵ}_{0}} {\sum }_{kl} {p}_{ijkl} ( \frac{\partial {u}_{k}}{\partial {x}_{l}} + \frac{\partial {u}_{l}}{\partial {x}_{k}} ) {E}_{0} ]$$

For our interests of AOBS efficiency, the acousto-optic scattering rate α of the guided mode E0 can be found from the equation,

$$α = \frac{2 Im ( {ω}_{1} )}{{v}_{g}} = - Re ( \frac{〈 {E}_{0} \vert J 〉}{{v}_{g} 〈 {E}_{0} \vert {ε}_{0} \vert {E}_{0} 〉} )$$

which can be numerically calculated based on simulation results.

### Example 6: Simulation and Optimization

We simulate the AOBS scattering and optimize the device design using the finite element method (FEM) software, COMSOL Multiphysics. The simulated unit cell model is shown in FIGS. 8A and 8B. As discussed in Example 5, due to the acoustic wave induced periodic perturbation to the permittivity of the waveguide, the guided optical mode is scattered to the radiative modes, and the new eigenmode of the perturbed waveguide becomes a weakly-guided mode with the scattering rate α, with Pg being the guide optical power and ∂Pg/∂z=−αPg.

The output optical power of the simulation domain is, Pout=Pin=Pg+Psu+Psl, where Pin is the injected optical power, Psu and Psl are the upward and downward radiative mode power, respectively. From energy conservation,

$$\frac{\partial {P}_{g}}{\partial z} + \frac{\partial ( {P}_{su} + {P}_{sl} )}{\partial z} = 0 ,$$

we can have

$$\frac{\partial ( {P}_{su} + {P}_{sl} )}{\partial z} = - \frac{\partial {P}_{g}}{\partial z} = α {P}_{in} .$$

By setting the upper and lower boundary of the simulation domain as the perfect-matched-layer, the vertically outgoing optical power could be considered as the radiative loss. Therefore, similar to the previous perturbation theory, the eigenfrequency becomes complex, where co-co-ix and the scattering rate is α=21/vg.

We performed both 2D and 3D simulations to optimize the LN thin film thickness and the buried oxide (BOX) thickness to maximize the upward scattering rate. In the 2D simulation, we only considered the moving boundary effect, which is modeled as the sinusoidal deformation at the waveguide boundary. In the 3D simulation, we considered both the photoelastic effect and the moving boundary effect. In both simulations, we assume that the orientation of LN is x-cut and the acoustic wave propagates along the y-axis to have a high Rayleigh mode excitation efficiency.

The full simulation includes three steps: First, the group velocity of the optical slab mode of the LNOI substrate (or LN only) is simulated. Then the acoustic mode, which is the Rayleigh-like acoustic mode, is simulated to calculate the displacement field. The acoustic wavelength was selected to meet the phase matching conditions. Finally, the acoustic wave induced permittivity changing is introduced to solve for the new eigenmodes.

Besides the moving boundary effect and the direct photoelastic effect, we also included the roto-optic effect and the indirect elasto-optic effect in our simulation since lithium niobate is both birefringent and piezoelectric. The latter two effects introduce an extra permittivity perturbation due to the additional elasto-optic component. For the roto effect, the permittivity changing is, Δ(εij)′=pijkl′Rkl, where

$${R}_{kl} = \frac{{S}_{kl} - {S}_{lk}}{2} .$$

The indirect elasto-optic effect occurs as the result of the piezoelectric effect and electro-optic effect in tandem, and the effective elasto-optic tensor for such effect is given by,

$${p}_{ij}^{*} = {p}_{ij} - \frac{{r}_{im} {Λ}_{m} {e}_{jn} S {Λ}_{n}}{{ε}_{mn} {Λ}_{m} {Λ}_{n}} ,$$

where pij is the direct elasto-optic tensor, rim is the electro-optic tensor, ejn is the piezoelectric tensor, and Λm is the unit acoustic wave vector. The material parameters are taken from [4].

To start the optimization, we defined the effective acousto-optic (AO) scattering length as L=1/α. Neglecting acoustic wave decaying, the solution of the optical power gives,

$$( {P}_{su} + {P}_{sl} ) = {P}_{0} - {P}_{g} = {P}_{0} ( 1 - exp ( - \frac{z}{L} ) )$$

The upward scattering efficiency is then defined as ρ=Psu/(Psu+Psl).

We first optimized the thickness of the LN thin film of a free-standing LN waveguide. Afterward, we search for the optimal thickness of the BOX layer of the LNOI when the back reflection from the BOX/silicon interface can enhance the upward scattering.

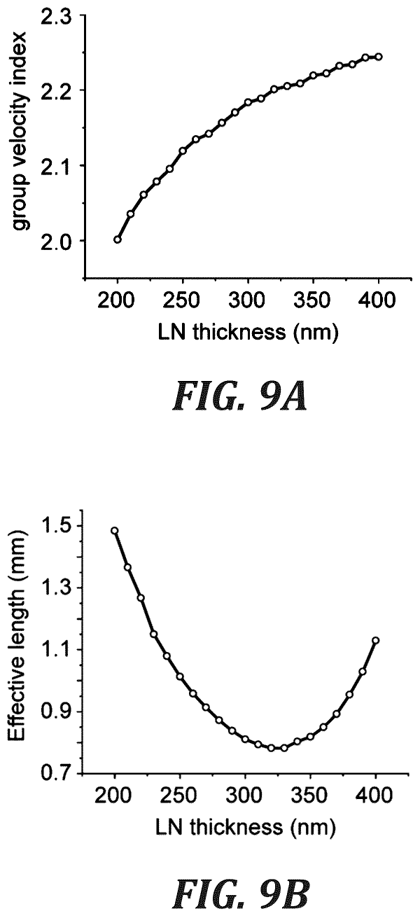

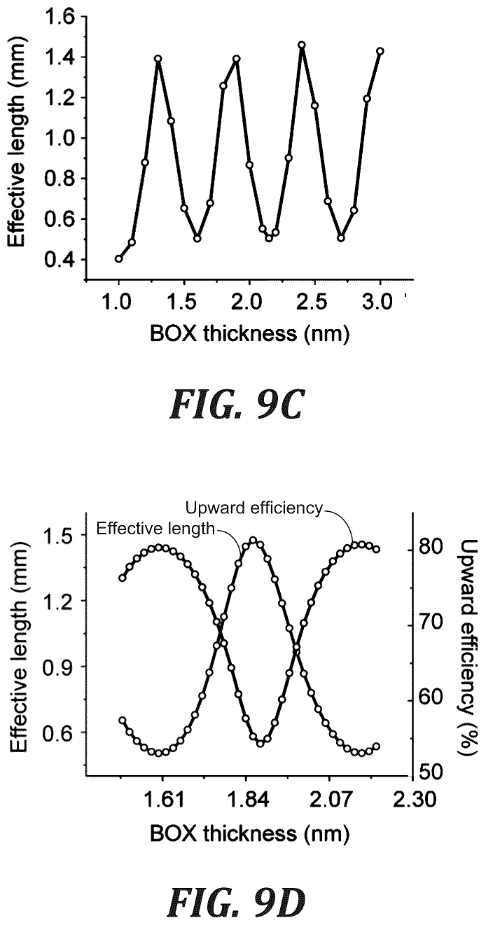

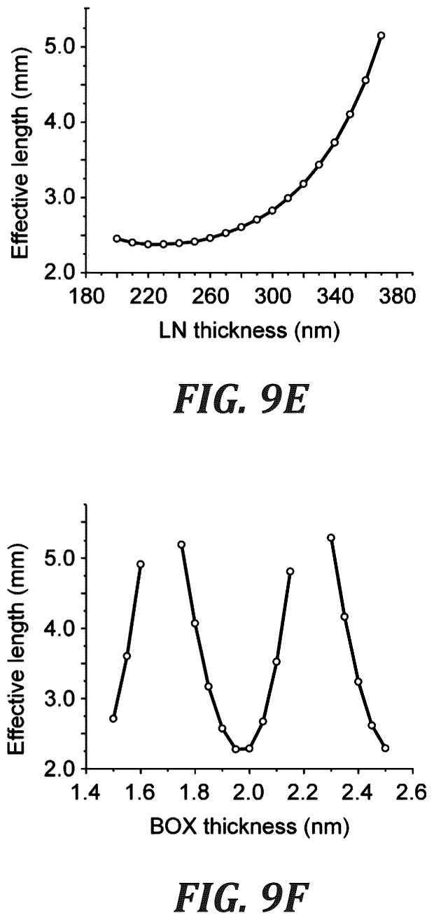

FIG. 9A shows the optical group index of the TE0 slab mode as a function of the LN layer thickness. When optimizing the LN thickness, a boundary deformation amplitude of 5 nm is assumed. FIG. 9B shows that the simulated effective AO scattering length L dependence on the LN thickness reaches a minimum at 330 nm, corresponding to the highest scattering efficiency. FIGS. 9C and 9D show that L and f have a periodic dependence on the BOX thickness, as expected from the interference effect.

FIGS. 9E and 9F show the 3D optimization results in which L as a function of the LN layer and the BOX layer thickness are plotted. An acoustic power of 10 mW/μm is assumed. The minimal L is reached at the LN thickness of 220 nm, which differs from the 2D results. Nevertheless, the difference of L between 220 and 330 nm is quite small. For practical considerations of a better LN thin film quality and stronger piezoelectricity, we chose LNOI substrates with 300 nm thick LN with a moderate compromise of the scattering efficiency as predicted by the simulation. With 300 nm LN thickness, FIG. 9F shows a periodic dependence of L to the BOX thickness. Based on that, we chose the 2 μm thick BOX such that the corresponding upward scattering efficiency reaches 80%, and the effective scattering length L is as short as 2.2 mm.

### Example 7: Real-Space AOBS Beam Profile Fitting Model

The real-space beam-profile image shown in FIG. 3C indicates that the emission from the AOBS decays along the acoustic wave propagation direction, due to the significant acoustic propagation loss in the waveguide. We can write down the differential equations to describe the scattering process of both acoustic waves and optical waves. Both the acoustic wave and the optical modes decay when propagating due to the AO scattering and intrinsic loss. To estimate the AO scattering rate and acoustic propagation loss, we assume the intrinsic optical loss is low and the optical loss is dominated by the AO scattering. The depletion of acoustic power during the AO scattering can also be neglected compared to its attenuation. Under these assumptions, the acoustic power density Pa and the input optical power Po can be written as,

$${\partial }_{x} {P}_{o} = κ {P}_{a} {P}_{o}$$

$${\partial }_{x} {P}_{a} = - γ {P}_{a}$$

where κ is the acousto-optic scattering rate. Suppose the source of the acoustic wave is at x=0 (front edge of the IDT), by solving the above equations, the expressions for the acoustic mode, optical guided mode, and the AO scattering power Pr are expressed by, respectively,

$${P}_{a} ( x ) = {e}^{- γ x} {P}_{a} ( 0 )$$

$${P}_{o} ( x ) = {e}^{\frac{κ′}{γ} ( {e}^{- γ l} - {e}^{- γ x} )} {P}_{o} ( l )$$

$${P}_{r} ( x ) = - {\partial }_{x} {P}_{o} ( x ) = {κ}^{′} {P}_{o} ( l ) {e}^{\frac{{κ}^{′}}{γ} ( {e}^{- γ l} - {e}^{- γ x} ) - γ x}$$

where κ′=κPa(0). The overall scattering efficiency is thus:

$$η = \frac{{\int }_{0}^{l} {P}_{r} ( x )}{{P}_{o} ( 0 )} = 1 - {e}^{\frac{{κ}^{′}}{γ} ( {e}^{- γ l} - 1 )}$$

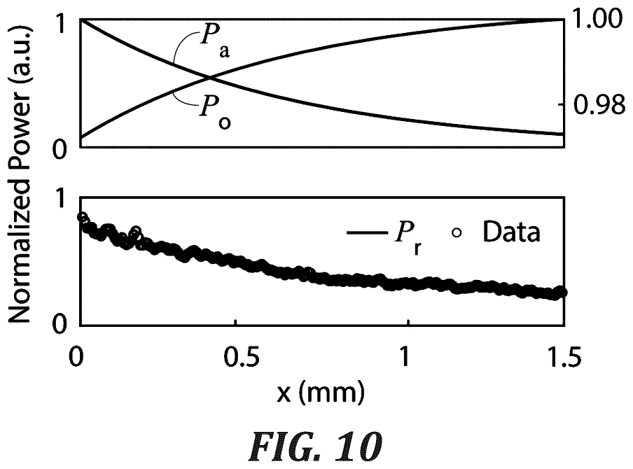

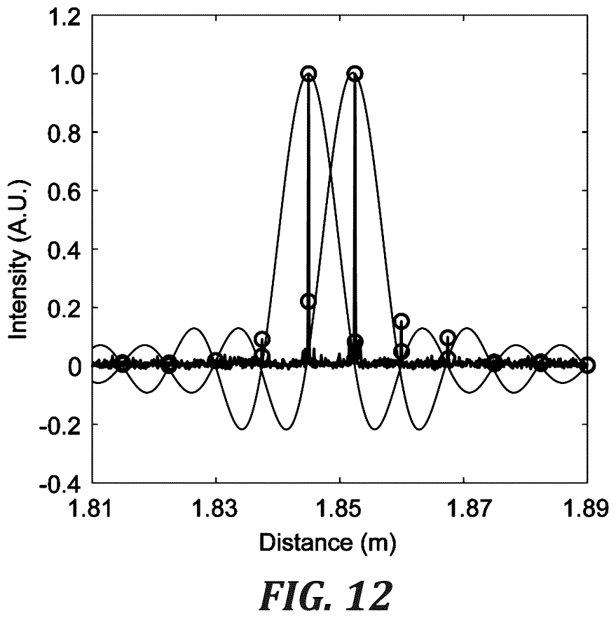

The scattered optical power Pr(x) is captured by the camera as the real-space image of the scattering intensity at the AOBS aperture. Therefore, by fitting the light intensity in FIG. 3C with Pr(x), we can extract the AO scattering rate of κ′=0.23 dB/mm and an acoustic propagation loss of γ=7.08 dB/mm. The corresponding acoustic propagation length is 0.6 mm. The overall AO scattering efficiency is η=2.8%. See FIG. 10. See also FIG. 12.

If the acoustic loss can be reduced, by improving the material quality, the efficiency η can be significantly improved. For example, if γ can be reduced to 0.2 cm-1 (acoustic decay length 5 cm), the efficiency η if 22% in an AOBS device with 5 mm long aperture and 1 mW/μm acoustic power density, while the efficiency can even reach 92%, with an increased 10 mW/μm acoustic power density, which are both realistic.

### Example 8: IDT Characterization

The reflection coefficient (S11) of the IDT was measured with a vector network analyzer (VNA). From the S11 spectra, we characterized the electromechanical coupling of the IDT using the modified Butterworth-Van Dyke (mBVD) model, from which the electromechanical conversion efficiency can be calculated.

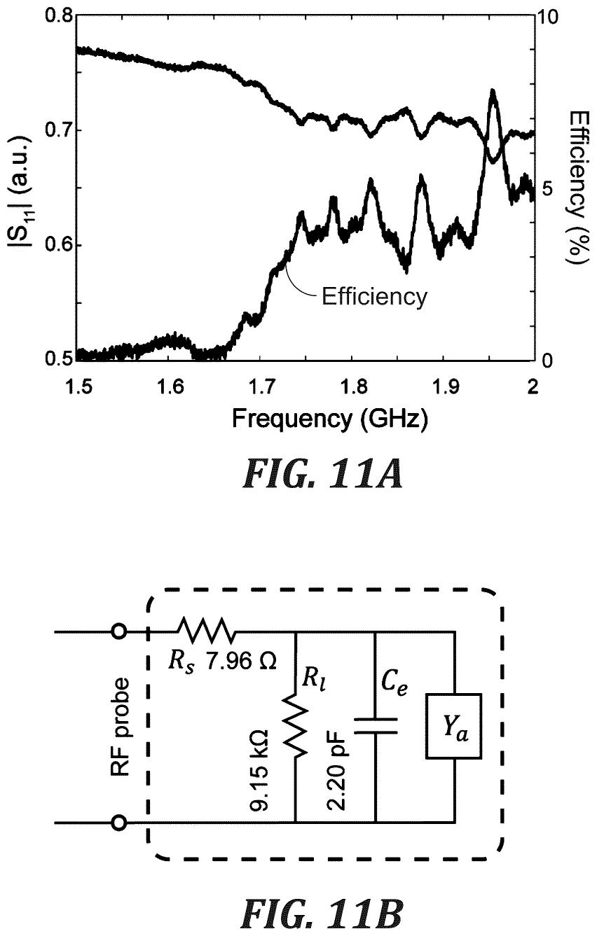

FIG. 11A shows the measured S11 spectra and the electromechanical conversion efficiency of the Rayleigh mode. FIG. 11B shows the equivalent circuit model with parameters extracted from the experimental data. The series resistor Rs accounts for the total series resistance between the RF probe and the IDT fingers. The admittance of IDT fingers can be written as,

$$Y ( f ) = {R}_{l} + j ω {C}_{e} + {G}_{a} ( f ) + j ω {B}_{a} ( f )$$

where the shunt resistor Rl and the capacitor Ce accounts for the effective leakage resistance and electrode capacitance between the IDT fingers, respectively. The complex, frequency-dependent admittance Ya(f)=Ga(f)+jωBa(f), represents the electromechanical response of the IDT, where the dissipated power is transduced into the acoustic wave.

From the measured S11, the load impedance ZL(f) can be calculated from the equation ZL=R0×(1+S11)/(1−S11), where the characteristic resistance R0=50Ω. Assuming the Rs, Rl and Ce are constant over the IDT bandwidth, the three parameters can be estimated by fitting the ZL around the frequency of interest with Ya open-circuited. Ya(f) is thus obtained. Then the power distribution on each component can be calculated according to the equivalent circuit model. The electromechanical conversion efficiency can be calculated by the power dissipated on Ya over the total input power,

$${η}_{E M} = {P}_{Y a} / {P}_{i n} .$$

### Example 9: Analysis of the FMCW Measurement

The chirping signal that is used to modulate the laser in the FMCW measurement was generated by AWG. It can be expressed as,

$${V}_{c} = sin [ 2 π ( {f}_{0} t + F ( t ) ) ] .$$

F(t) is characterized by

$${f}_{\pm } ( t ) = \frac{{dF}_{\pm } ( t )}{dt} = \pm {f}_{E} t / T ,$$

for the rising (+) and falling (−) edge of the chirping signal. The period is T, the frequency excursion is fE=f1−f0, and the chirp rate is g±=±2(f1−f0)/T.

This signal was then used to drive the EOM. The modulated optical field is,

$$\begin{matrix}{E}_{m} = {e}^{j [ ω t + δ sin ( 2 π F ( t ) ) ]} \\ = {\sum }_{- ∞}^{+ ∞} {J}_{n} ( δ ) {e}^{j ( ω t + 2 n π F ( t ) )}\end{matrix}$$

where δ is the modulation strength and Jv(x) is the v-th order Bessel function of the first kind.

The chirped light was split to two parts. One was sent to the AOBS device, which was then diffracted by the acoustic wave of frequency Ω. The other part was used as the LO. The scattered light was frequency shifted by the acoustic such that it can be expressed

$${E}_{b s} = {\sum }_{- ∞}^{+ ∞} {J}_{n} ( δ ) {e}^{j ( ω t + Ω t + 2 n π F ( t ) )}$$

The received field obtains a phase delay τ=2R/c over a range R,

$${E}_{r} = {\sum }_{- ∞}^{+ ∞} {J}_{n} ( δ ) {e}^{j [ ( ω + Ω ) ( t + τ ) + 2 n π F ( t + τ ) ]}$$

The received signal was combined with the LO by a 50/50 fiber coupler. The output of the fiber coupler was detected by a BPD. The voltage output of the BPD can be written as,

$${V}_{B} ∝ 4 Im ( {E}_{r} {E}_{L O}^{*} )$$

The generated beating signal was then measured by an RSA. If we consider the first order sideband of the EOM modulated light, the output voltage of the BPD consists of nine terms. Within the RSA measurement bandwidth, there are three frequency components centered at Ω and Ω±f_{B}. The corresponding signals come from the following beating terms between the baseband and the frequency-shifted signals:

$${V}_{0} ( t , τ ) ∝ {{J}_{0} ( δ )}^{2} sin ( Ω t + {ϕ}_{0} ) )$$

$${V}_{1} ( t , τ ) ∝ {{J}_{1} ( δ )}^{2} sin [ Ω t + 2 π F ( t - τ ) - 2 π F ( t ) + {ϕ}_{1} ] ]$$

$${V}_{- 1} ( t , τ ) ∝ {{J}_{- 1} ( δ )}^{2} sin [ Ω t - 2 π F ( t - τ ) + 2 π F ( t ) + {ϕ}_{- 1} ] ]$$

where ϕ0, ±1 are time independent phases in each term. We need to mention that V0 is a single-frequency signal, while the signals of the V1 and V−1 are both phase modulated by the linear chirping drive F(t). The angular information is carried by the RF frequency Ω, and distance information can be extracted from the beating between the LO and the received signal [F(t−τ)−F(t)], which is a periodic function with period T. To analyze the beating of the chirped signals, we use V1(t, τ) as an example and do Fourier expansion to obtain amplitudes at each harmonic,

$${V}_{1} ∝ sin [ Ω t + 2 π F ( t - τ ) - 2 π F ( t ) + {ϕ}_{1} ] = sin ( Ω t + {ϕ}_{1} ) cos ( 2 π F ( t - τ ) - 2 π F ( t ) ) + cos ( Ω t + {ϕ}_{1} ) sin ( 2 π F ( t - τ ) - 2 π F ( t ) ) ,$$

For simplicity, we considered the signal as an infinitely long periodic function. In this case, the frequency modulated sine and cosine terms can be expanded as Fourier series,

$$cos [ 2 π ( F ( t - τ ) - F ( t ) ) ] = \frac{{a}_{0}}{2} + {\sum }_{n = 1}^{∞} {a}_{n} cos ( \frac{2 π nt}{T} ) ,$$

$$sin [ 2 π ( F ( t - τ ) - F ( t ) ) ] = \frac{{b}_{0}}{2} + {\sum }_{n = 1}^{∞} {b}_{n} sin ( \frac{2 π nt}{T} ) .$$

By calculating the Fourier coefficients and assuming τ<<T, the beating signal can be rewritten as,

$${V}_{1} ∝ sin ( Ω t + {ϕ}_{1} \pm {ϕ}^{′} ) {\sum }_{n = 1}^{∞} [ sin c ( 2 {f}_{E} τ + n ) + sin c ( 2 {f}_{E} τ - n ) ] cos ( \frac{2 π nt}{T} ) \pm cos ( Ω t + {ϕ}_{1} \pm {ϕ}^{′} ) {\sum }_{n = 1}^{∞} ∓ [ sin c ( 2 {f}_{E} τ - n ) - sin c ( 2 {f}_{E} τ + n ) ] sin ( \frac{2 π nt}{T} ) = sin c ( 2 {f}_{E} τ + n ) sin ( Ω t + \frac{2 n π t}{T} + {ϕ}_{1} + {ϕ}^{′} ) + sin c ( 2 {f}_{E} τ - n ) sin ( Ω t - \frac{2 n π t}{T} + {ϕ}_{1} - {ϕ}^{′} )$$

The V−1 has a similar expression. The output voltage BPD at Ω and Ω±fB are,

$${V}_{FAR} ( t , τ ) ∝ {{J}_{0} ( δ )}^{2} cos ( Ω t )$$

$${V}_{USB} ( t , τ ) ∝ {{J}_{1} ( δ )}^{2} {\sum }_{n = 1}^{∞} sin c ( 2 {f}_{E} τ - n )$$

$$\{ cos [ 2 π ( Ω + \frac{n}{T} ) t + {ϕ}_{1} - {ϕ}^{′} ] + cos [ 2 π ( Ω + \frac{n}{T} ) t + {ϕ}_{- 1} - {ϕ}^{′} ] \}$$

$${V}_{LSB} ( t , τ ) ∝ {{J}_{1} ( δ )}^{2} {\sum }_{n = 1}^{∞} sin c ( 2 {f}_{E} τ + n ) \text{}$$

$$\{ cos [ 2 π ( Ω + \frac{n}{T} ) t + {ϕ}_{1} + {ϕ}^{′} ] + cos [ 2 π ( Ω + \frac{n}{T} ) t + {ϕ}_{- 1} + {ϕ}^{′} ] \}$$

It shows that the repetition of the chirp signal induced discrete peaks with an equal spacing 1/T, starting from the RF frequency Ω. Therefore, ranging resolution by global maximum peak detection method is limited by,

$$\frac{2 Δ R}{c} \frac{2 {f}_{E}}{T} \geq \frac{1}{T}$$

$$Δ R \geq \frac{c}{4 {f}_{E}}$$

To achieve higher ranging resolution, we used sine functions to fit the beating signal. The center of the sinc function shows a fitted depth and the resolution is defined by fitting error.

### Example 10: AOBS Results of Visible Light

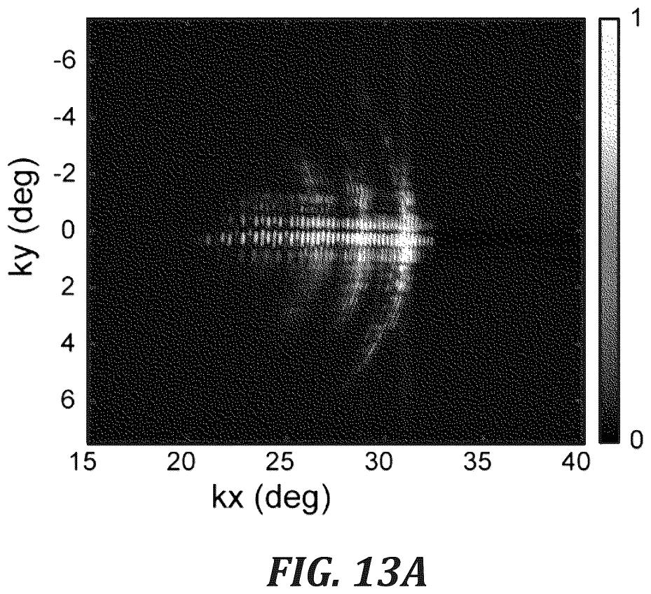

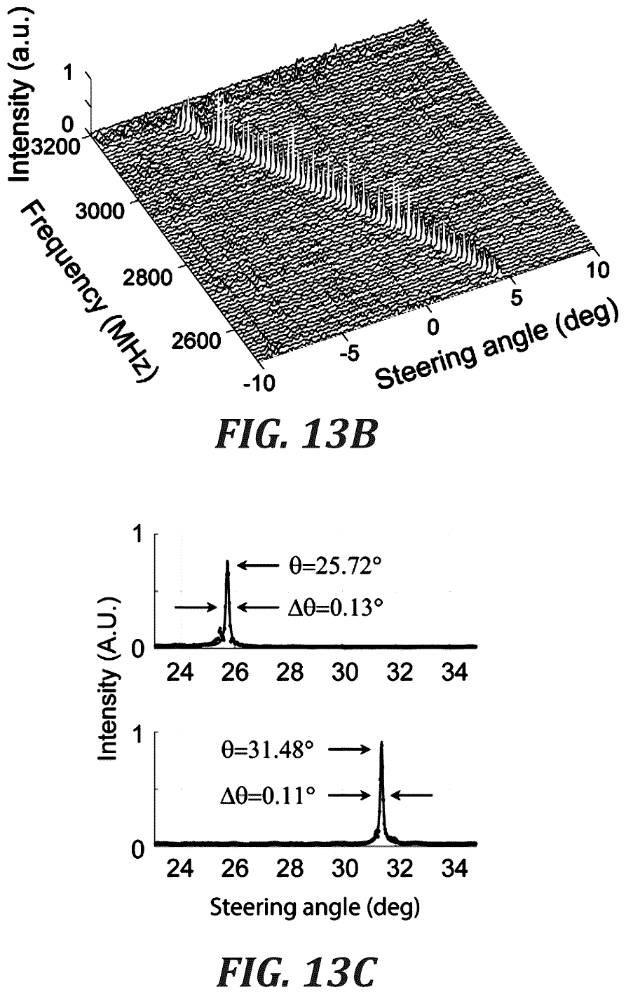

The LNOI platform support a wide spectral range from the visible to the infrared. We demonstrate visible light AOBS here. The visible light optical characterization setup was as same as the infrared except for the light source and camera. We used the external cavity tunable diode laser (Velocity TLB6712) to generate 780 nm light and the visible camera (Teledyne Infinity2) to capture the emitting beams. The results are shown in FIGS. 13A-13C.

The above description of illustrated embodiments of the disclosure, including what is described in the Abstract, is not intended to be exhaustive or to limit the disclosure to the precise forms disclosed. While specific embodiments of, and examples for, the disclosure are described herein for illustrative purposes, various modifications are possible within the scope of the disclosure, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

1. A system for Frequency Angular Resolving (FAR) light detection and ranging (LIDAR), the system comprising:
a transmitter comprising:
a source of electromagnetic radiation;
a driver circuit configured to generate a drive signal at an oscillation frequency;
an acousto-optical beam steering device optically coupled with the source of electromagnetic radiation and the driver circuit and configured to emit electromagnetic radiation at an emission angle as a function of the oscillation frequency; and
a receiver comprising:
a radiation sensor optically coupled with the source of electromagnetic radiation.

2. The system of claim 1, wherein the transmitter further comprises an electro-optic modulator optically coupled to the source of electromagnetic radiation, the electro-optic modulator configured to modulate a frequency of light emitted to the acousto-optical beam steering device.

3. The system of claim 2, wherein the receiver further comprises a local oscillator positioned to receive incident electromagnetic radiation reflected off an object outside the system and electromagnetic radiation from the source of electromagnetic radiation, wherein the radiation sensor is configured to receive from the local oscillator the incident electromagnetic radiation reflected off the object outside the system and the electromagnetic radiation from the source of electromagnetic radiation.

4. The system of claim 3, further comprising a controller operatively coupled to the receiver and the transmitter, wherein the controller includes logic that, when executed, causes the system to perform operations including:
modulating with the electro-optic modulator the frequency of light emitted to the acousto-optical beam steering device;
beating with the local oscillator the incident electromagnetic radiation reflected off the object outside the system and the electromagnetic radiation from the source of electromagnetic radiation;
measuring a frequency of the beating with the radiation sensor; and
determining a distance between the system and the object outside the system based on the frequency of the beating.

5. The system of claim 1, wherein the acousto-optical beam steering device comprises an acousto-optic deflector.

6. The system of claim 5, wherein the acousto-optic deflector is configured to confine an acoustic wave generated by the driver circuit and an optical wave generated by the source of electromagnetic radiation in a planar waveguide structure of the acousto-optic deflector.

7. The system of claim 1, wherein the oscillation frequency is in a range from 0.1 GHz to 10 GHz.

8. The system of claim 1, wherein the radiation sensor is configured to sample incident radiation at a sampling frequency of 1 kHz or greater.

9. The system of claim 1, wherein the radiation sensor comprises a photodetector.

10. The system of claim 1, wherein the electromagnetic radiation is first electromagnetic radiation, and wherein the radiation sensor is configured to combine the first electromagnetic radiation coupled in from the source of electromagnetic radiation with second electromagnetic radiation as the reflection of the first electromagnetic radiation from an environment of the system.

11. The system of claim 1, wherein:
the drive signal is a first drive signal;
the oscillation frequency is a first oscillation frequency;
the emission angle is a first emission angle;
the driver circuit is further configured to generate a second drive signal at a second oscillation frequency; and
the acousto-optical beam steering device is further configured to emit electromagnetic radiation at a second emission angle as a function of the second oscillation frequency, the second emission angle different from the first emission angle.

12. The system of claim 11, wherein the acousto-optical beam steering device is further configured to emit electromagnetic radiation at the first emission angle and at the second emission angle concurrently.

13. The system of claim 1, wherein the electromagnetic radiation comprises photons having an energy outside an energy range that is visible to humans.

14. The system of claim 1, wherein the electromagnetic radiation comprises photons having an energy in an energy range that is visible to humans.

15. The system of claim 1, wherein the emission angle is in a range from −90 degrees to +90 degrees relative to a normal vector of an emission surface of the acousto-optical beam steering device.

16. The system of claim 1, wherein the transmitter comprises:
a plurality of driver circuits including the driver circuit, wherein driver circuits of the plurality of driver circuits are configured to generate a drive signal at an oscillation frequency; and
a plurality of acousto-optical beam steering devices including the acousto-optical beam steering, wherein acousto-optical beam steering devices of the plurality of acousto-optical beam steering devices are optically coupled with the source of electromagnetic radiation and the driver circuit and configured to emit electromagnetic radiation at an emission angle as a function of the oscillation frequency, and wherein a first acousto-optical beam steering device of the plurality of acousto-optical beam steering devices is positioned to emit electromagnetic radiation from a first portion of the transmitter and a second acousto-optical beam steering device of the plurality of acousto-optical beam steering devices is configured to emit electromagnetic radiation from a second portion of the transmitter.

17. A module comprising:
a first system according to claim 1, wherein the first system has a first major axis directed in a first orientation; and
a second system according to claim 1, wherein the second system has a second major axis directed in a second orientation, wherein the second orientation is different than the first orientation.

18. A method of Frequency Angular Resolving (FAR), the method comprising:
generating electromagnetic radiation using a source of electromagnetic radiation;
generating a drive signal using driver circuitry, the drive signal comprising an alternating current electrical signal at an oscillation frequency;
actuating an acousto-optic deflector at the oscillation frequency using the drive signal, the acousto-optic deflector being optically coupled with the source of electromagnetic radiation;
irradiating the acousto-optic deflector with a first portion of the electromagnetic radiation, thereby generating a steered beam at an emission angle, the emission angle being a function of the oscillation frequency;
receiving reflected electromagnetic radiation at a radiation sensor optically coupled with the source of electromagnetic radiation, the reflected electromagnetic radiation originating from an interaction of a surface in an environment of the radiation sensor with the steered beam;
generating an interference signal using the reflected electromagnetic radiation and a second portion of the electromagnetic radiation; and
determining one or more characteristics of the surface using the interference signal.

19. The method of claim 18, wherein determining the one or more characteristics of the surface comprises determining an angular position of the surface relative to the acousto-optic deflector.

20-25. (canceled)

21. A non-transitory machine-readable memory storing instructions that, when executed by a machine, cause the machine to perform operations comprising:
generating electromagnetic radiation using a source of electromagnetic radiation;
generating a drive signal using driver circuitry, the drive signal comprising an alternating current electrical signal at an oscillation frequency;
actuating an acousto-optic deflector at the oscillation frequency using the drive signal, the acousto-optic deflector being optically coupled with the source of electromagnetic radiation;
irradiating the acousto-optic deflector with a first portion of the electromagnetic radiation, thereby generating a steered beam at an emission angle, the emission angle being a function of the oscillation frequency;
receiving reflected electromagnetic radiation at a radiation sensor optically coupled with the source of electromagnetic radiation, the reflected electromagnetic radiation originating from an interaction of a surface in an environment of the radiation sensor with the steered beam;
generating an interference signal using the reflected electromagnetic radiation and a second portion of the electromagnetic radiation; and
determining one or more characteristics of the surface using the interference signal.
